(19) United States
(12) Patent Application Publication
(10) Pub. No.: US 2026/0288573 A1
(43) Pub. Date: Sep. 24, 2026

(54) Decoding Using Soft Information from Multiple Oligo Copies in DNA Data Storage

(71) Applicant: Western Digital Technologies, Inc., San Jose, CA (US)

(72) Inventors: Iouri Oboukhov, Rochester, MN (US); Richard Galbraith, Rochester, MN (US); Niranjay Ravindran, Rochester, MN (US); Austin Striegel, Rochester, MN (US)

(21) Appl. No.: 19/082,690

(22) Filed: Mar. 18, 2025

(51) Int. Cl. G06F 11/10

(52) U.S. Cl. CPC G06F 11/10

(57) ABSTRACT

Example systems and methods for using soft information from oligo copies in a set of oligos for improved decoding in DNA data storage are described. Read data from an oligo pool may include a variable number of copies of each oligo in the set. During decoding, a convolutional matrix may be constructed for each copy of an oligo and used to generate a corresponding correlation matrix. Calculation of a most likely path through the correlation matrix may generate a set of soft information for each element in the correlation matrix and consensus averaging of the sets of soft information from multiple copies may be used to determine a consensus most likely path for at least correcting insertions and deletions.

### TECHNICAL FIELD

The present disclosure relates to deoxyribonucleic acid (DNA) data storage. In particular, the present disclosure relates to error correction for data stored as a set of synthetic DNA oligos.

### BACKGROUND

DNA is a promising technology for information storage. It has potential for ultra-dense three-dimensional (3D) storage with high storage capacity and longevity. Currently, the technology of DNA synthesis provides tools for synthesis and manipulation of relatively short synthetic DNA chains (oligos). For example, some oligos may include 40 to 350 bases encoding twice that number of bits in configurations that use bit symbols mapped to the four DNA nucleotides or sequences thereof. Due to the relatively short payload capacity of oligos, Reed-Solomon error correction codes have been applied to individual oligos.

There is a need for technology that applies more efficient error correction to DNA data storage and retrieval.

### BRIEF DESCRIPTION OF THE DRAWINGS

The techniques introduced herein are illustrated by way of example, and not by way of limitation, in the figures of the accompanying drawings in which like reference numerals are used to refer to similar elements.

FIG. 1A is a block diagram of a prior art DNA data storage process.

FIG. 1B is a block diagram of a prior art DNA data storage decoding process for oligos encoded with binary data.

FIG. 2 is a block diagram of an example encoding system and example decoding system for DNA data storage using soft information for consensus correction.

FIGS. 3A and 3B are diagrams of oligo processing to determine the reference marks in oligo read data.

FIG. 4 is a block diagram of an oligo data processing system using soft information consensus to improve error correction and decoding.

FIGS. 5A, 5B, and 5C are diagrams of using soft information from a correlation matrix to determine consensus probabilities for each base pair.

FIG. 5D is a diagram of using hard decisions from multiple copies to determine soft information based on consensus probabilities for each base pair,

FIGS. 6A, 6B, and 6C are example methods for recovering reference mark timing and user data using consensus of soft information, such as using the decoding systems of FIGS. 2 and 4.

FIG. 7 is an example method for encoding reference marks in oligos, such as using the encoding system of FIG. 2.

FIG. 8 is an example method for determining probabilities of reference mark shifts and associated soft information using a Viterbi algorithm, such as using the decoding systems of FIGS. 2 and 4.

### SUMMARY

Various aspects for using soft information from correlation matrices for multiple copies of the oligo to decode data stored in an oligo pool for DNA data storage are described.

One general aspect includes a system that includes at least one decoder circuit configured to, alone or in combination: receive read data determined from sequencing a set of oligos that includes multiple copies of an oligo and corresponds to at least a portion of an oligo pool configured to store a data unit; determine, from the read data for each copy of the oligo, a convolutional matrix for that copy of the oligo, where each column of the convolutional matrix corresponds to a base pair offset of the read data for that copy of the oligo; determine, for each copy of the oligo, a correlation matrix based on a comparison of the convolutional matrix for that copy of the oligo to a reference matrix; determine, for each copy of the oligo, a most likely path through the correlation matrix for that copy of the oligo, where calculation of the most likely path generates a set of soft information for each element in the correlation matrix for that copy of the oligo; determine, based on consensus averaging of the sets of soft information from at least two copies of the oligo, a consensus most likely path for the oligo; and decode the oligo based on insertions and deletions indicated by the consensus most likely path.

Implementations may include one or more of the following features. The reference matrix may correspond to a reference pattern encoded in the oligo as a series of reference marks having a predetermined interval; and the predetermined interval of the series of reference marks may correspond to a single base pair between sequential reference marks in the series of reference marks. The at least one decoder circuit may be further configured to, alone or in combination: select the reference matrix from a plurality of reference matrices corresponding to different reference patterns in a set of reference patterns used to encode the reference marks in an oligo pool including the oligo; iteratively execute, for the plurality of reference matrices: determining the correlation matrix for that reference matrix; and determining the most likely path for that reference matrix; and determine, based on a comparison of the set of soft information for each reference matrix of the plurality of reference matrices, a most likely reference pattern for that copy of the oligo. A number of the multiple copies of the oligo in the read data may be less than 10. Determining the consensus most likely path for the oligo may include: for each copy of the oligo, aggregating, for each base pair along a length of that copy of the oligo, a probability of each possible base pair; consensus averaging, across the copies of the oligo, the probabilities of each possible base pair; and using a maximum probability value among the consensus averaged probabilities of each possible base pair to determine the most likely path. Determining the consensus most likely path for the oligo may include: determining, based on the reference matrix for each copy of the oligo, positions in the correlation matrix for that copy of the oligo that correspond to a series of reference marks for that copy of the oligo; and consensus averaging the soft information corresponding to the series of reference marks for each copy of the oligo to determine a most likely reference pattern for use in determining insertion and deletion errors in the at least two copies of the oligo. The at least one decoder may include a plurality of consensus functions and the at least one decoder circuit may be further configured to, alone or in combination: determine a number of the multiple copies of the oligo; and select, based on the number of the multiple copies, at least one consensus function of the plurality of consensus functions for determining the consensus most likely path. Selecting the at least one consensus function of the plurality of consensus functions may include: selecting a first consensus function from the plurality of consensus functions responsive to the number of multiple copies of the oligo meeting a threshold number of copies; and selecting a second consensus function from the plurality of consensus functions responsive to the number of multiple copies of the oligo not meeting the threshold number of copies. Selecting the at least one consensus function of the plurality of consensus functions may include: selecting a first consensus function and a second consensus function from plurality of consensus functions; and determining, based on the number of multiple copies of the oligo, a weighting value for determining relative contributions of the first consensus function and the second consensus function. Determining the consensus most likely path may be based on the first consensus function, the second consensus function, and the weighting value applied to the sets of soft information from the multiple copies of the oligo. The read data for the oligo pool may include a distribution of numbers of copies of different oligos in the oligo pool; and the read data may be configured for the distribution to have a mean value in a range of 3 to 7 copies.

Another general aspect includes a method that includes: receiving read data determined from sequencing a set of oligos that includes multiple copies of an oligo and corresponds to at least a portion of an oligo pool configured to store a data unit; determining, from the read data for each copy of the oligo, a convolutional matrix for that copy of the oligo, where each column of the convolutional matrix corresponds to a base pair offset of the read data for that copy of the oligo; determining, for each copy of the oligo, a correlation matrix based on a comparison of the convolutional matrix for that copy of the oligo to a reference matrix; determining, for each copy of the oligo, a most likely path through the correlation matrix for that copy of the oligo, where calculation of the most likely path generates a set of soft information for each element in the correlation matrix for that copy of the oligo; determining, based on consensus averaging of the sets of soft information from at least two copies of the oligo, a consensus most likely path for the oligo; and decoding the oligo based on insertions and deletions indicated by the consensus most likely path.

Implementations may include one or more of the following features. The reference matrix may correspond to a reference pattern encoded in the oligo as a series of reference marks having a predetermined interval; and the predetermined interval of the series of reference marks may correspond to a single base pair between sequential reference marks in the series of reference marks. The method may include: selecting the reference matrix from a plurality of reference matrices corresponding to different reference patterns in a set of reference patterns used to encode the reference marks in an oligo pool including the oligo; iteratively executing, for the plurality of reference matrices: determining the correlation matrix for that reference matrix; and determining the most likely path for that reference matrix; and determining, based on a comparison of the set of soft information for each reference matrix of the plurality of reference matrices, a most likely reference pattern for that copy of the oligo. The method may include: for each copy of the oligo, aggregating, for each base pair along a length of that copy of the oligo, a probability of each possible base pair; consensus averaging, across the copies of the oligo, the probabilities of each possible base pair; and using a maximum probability value among the consensus averaged probabilities of each possible base pair to determine the most likely path. The method may include: determining, based on the reference matrix for each copy of the oligo, positions in the correlation matrix for that copy of the oligo that correspond to a series of reference marks for that copy of the oligo; and consensus averaging the soft information corresponding to the series of reference marks for each copy of the oligo to determine a most likely reference pattern for use in determining insertion and deletion errors in the at least two copies of the oligo. The method may include: determining a number of the multiple copies of the oligo; and selecting, based on the number of the multiple copies, at least one consensus function from a plurality of consensus functions for determining the consensus most likely path. Selecting the at least one consensus function from the plurality of consensus functions may include: selecting a first consensus function from the plurality of consensus functions responsive to the number of multiple copies of the oligo meeting a threshold number of copies; and selecting a second consensus function from the plurality of consensus functions responsive to the number of multiple copies of the oligo not meeting the threshold number of copies. Selecting the at least one consensus function of the plurality of consensus functions may include: selecting a first consensus function and a second consensus function from plurality of consensus functions; and determining, based on the number of multiple copies of the oligo, a weighting value for determining relative contributions of the first consensus function and the second consensus function. Determining the consensus most likely path may be based on the first consensus function, the second consensus function, and the weighting value applied to the sets of soft information from the multiple copies of the oligo. The read data for the oligo pool may include a distribution of numbers of copies of different oligos in the oligo pool; and the read data may be configured for the distribution to have a mean value in a range of 3 to 7 copies.

Still another general aspect includes a system that includes: at least one processor; at least one memory; means for receiving read data determined from sequencing a set of oligos that includes multiple copies of an oligo and corresponds to at least a portion of an oligo pool configured to store a data unit; means for determining, from the read data for each copy of the oligo, a convolutional matrix for that copy of the oligo, where each column of the convolutional matrix corresponds to a base pair offset of the read data for that copy of the oligo; means for determining, for each copy of the oligo, a correlation matrix based on a comparison of the convolutional matrix for that copy of the oligo to a reference matrix; means for determining, for each copy of the oligo, a most likely path through the correlation matrix for that copy of the oligo, where calculation of the most likely path generates a set of soft information for each element in the correlation matrix for that copy of the oligo; means for determining, based on consensus averaging of the sets of soft information from at least two copies of the oligo, a consensus most likely path for the oligo; and means for decoding the oligo based on insertions and deletions indicated by the consensus most likely path.

The present disclosure describes various aspects of innovative technology capable of applying soft information from multiple copies of an oligo from a DNA oligo pool to consensus decision-making for decoding of user data stored in the DNA oligo pool. The consensus decision-making provided by the technology may be applicable to a variety of computer systems used to store or retrieve data stored as a set of oligos in a DNA storage medium. The configuration may be applied to a variety of DNA synthesis and sequencing technologies to generate write data for storage as base pairs and process read data read from those base pairs. The novel technology described herein includes a number of innovative technical features and advantages over prior solutions, including, but not limited to, improved data recovery based on elimination of insertion and deletion errors and more accurate consensus decisions for correcting user data.

### DETAILED DESCRIPTION

Prior methods for decoding data units encoded in DNA oligo pools have used consensus decision-making for base pairs, generally based on a high volume of oligo copies. For example, an oligo pool for a 512 kilobyte (KB) data block may include more than 50,000 unique oligos to encode the user data and associated redundancy data. Replication and amplification of those oligos to reliably use consensus-based decoding may represent significant overhead for both the DNA sequencing and subsequent data processing. For example, if reliable consensus processing requires at least 10 copies, then the amplification will need to target a much higher number of copies to achieve a desired distribution of randomly generated copies. Assuming a three sigma distribution (in each direction) that has at least 10 copies for 99.9% of the oligos, the mean number of copies targeted could be 100 or more and require replication, sequencing, and data processing of millions or billions of oligos.

However, improved data processing and error correction may reduce the number of copies for reliable consensus-based decoding stages that leverage multiple copies while not requiring the high number of copies. In addition, these improved consensus-based techniques may use the number of copies of each oligo in the read data from the pool to determine the consensus function used. More specifically, rather than direct consensus “voting” of individual base pair values across the multiple copies of the oligo, soft information from probabilistic determination of base pair values may be aggregated and compared to generate more accurate consensus averages. For example, the aggregation of Viterbi probabilities from a correlation matrix may provide more reliable consensus averages from far fewer copies and may even support some form of consensus improvement on as few as two copies. Consensus averaging across hard decisions from three or more copies may generate soft information corresponding to strength of consensus. These soft information consensus techniques may enable smaller read data sets that target a mean of 3-7 copies and less than 10 copies for the majority of the oligos in the set.

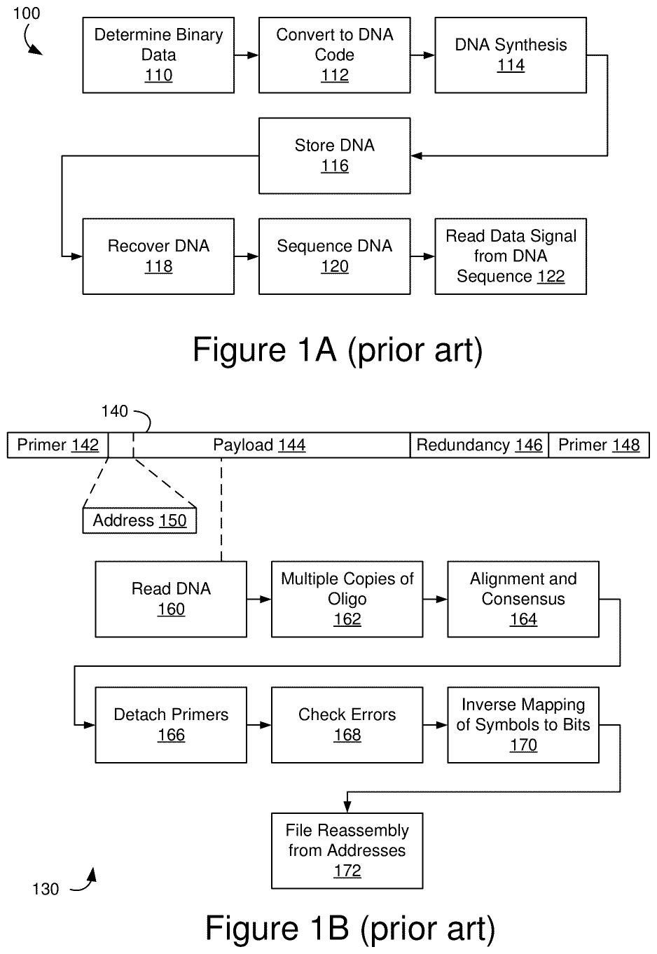

Novel data storage technology is being developed to use synthesized DNA encoded with binary data for long-term data storage. While current approaches may be limited by the time it takes to synthesize and sequence DNA, the speed of those systems is improving, and the density and durability of DNA as a data storage medium is compelling. In an example configuration in FIG. 1A, a method 100 may be used to store and recover binary data from synthetic DNA.

At block 110, binary data for storage to the DNA medium may be determined. For example, any conventional computer data source may be targeted for storage in a DNA medium, such as data files, databases, data objects, software code, etc. Due to the high storage density and durability of DNA media, the data targeted for storage may include very large data stores having archival value, such as collections of images, videos, scientific data, software, enterprise data, and other archival data. These conventional data sources may include data units for storage, such as data blocks of a particular size, such as 512 kilobyte (KB), 1 megabyte (MB), 2 MB, or 4 MB blocks.

At block 112, the binary data may be converted to DNA code. For example, a conventional computer data object or data file may be encoded according to a DNA symbol index, such as: A or T=1 and C or G=0; A=00, T=01, C=10, and G=11; or a more complex DNA symbol index mapping sequences of DNA bases to predetermined binary data patterns. In some configurations, prior to conversion to DNA code, the source data may be encoded according to an oligo-length format that includes addressing and redundancy data for use in recovering and reconstructing the source data during the retrieval process.

At block 114, DNA may be synthesized to embody the DNA code determined at block 112. For example, the DNA code may be used as a template for generating a plurality of synthetic DNA oligos embodying that DNA code using various DNA synthesis techniques. In some configurations, a large data unit is broken into segments matching a payload capacity of the oligo length being used, and each segment is synthesized in a corresponding DNA oligo. In some configurations, solid-phase DNA synthesis may be used to create the desired oligos. For example, each desired oligo may be built on a solid support matrix one base at a time to match the desired DNA sequence, such as using phosphoramidite synthesis chemistry in a four-step chain elongation cycle. In some configurations, column-based or microarray-based oligo synthesizers may be used.

At block 116, the DNA medium may be stored. For example, the resulting set of DNA oligos for the data unit may be placed in a fluid or solid carrier medium. The resulting DNA medium of the set of oligos and their carrier may then be stored for any length of time with a high-level of stability (e.g., DNA that is thousands of years old had been successfully sequenced). In some configurations, the DNA medium may include wells of related DNA oligos suspended in carrier fluid or a set of DNA oligos in a solid matrix that can themselves be stored or attached to another object. A set of DNA oligos stored in a binding medium may be referred to as a DNA storage medium for an oligo pool. The DNA oligos in the pool may relate to one or more binary data units comprised of user data (the data to be stored prior to encoding and addition of syntactic data, such as headers, addresses, reference marks, etc.).

At block 118, the DNA oligos may be recovered from the stored medium. For example, the oligos may be separated from the carrier fluid or solid matrix for processing. The resulting set of DNA oligos may be transferred to a new solution for the sequencing process or may be stored in a solution capable of receiving the other polymerase chain reaction (PCR) reagents.

At block 120, the DNA oligos may be sequenced and read into a DNA data signal corresponding to the sequence of bases in the oligo. For example, the set of oligos may be processed through PCR to amplify the number of copies of the oligos from the stored set of oligos. In some configurations, PCR amplification may result in a variable number of copies of each oligo.

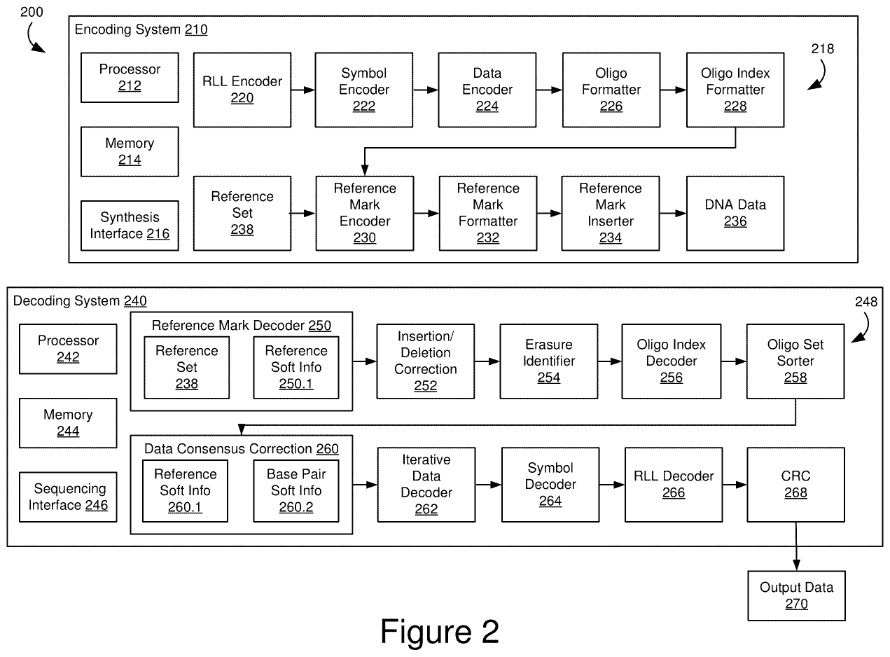

At block 122, a data signal may be read from the sequenced DNA oligos. For example, the sequenced oligos may be passed through a nanopore reader to generate an electrical signal corresponding to the sequence of bases. In some configurations, each oligo may be passed through a nanopore, and a voltage across the nanopore may generate a differential signal with magnitudes corresponding to the different resistances of the bases. The analog DNA data signal may then be converted back to digital data based on one or more decoding steps, as further described with regard to a method 130 in FIG. 1B. Improved systems and methods for processing read data from the sequenced oligos to recover the data encoded in the original oligo, including both address/index data and user data, are further described with regard to FIGS. 2-7.

In FIG. 1B, method 130 may be used to convert an analog read signal corresponding to a sequence of DNA bases back to the digital data unit that was the original target of the DNA storage process. In the example shown, the original digital data unit, such as a data file, was broken into data subunits corresponding to a payload size of the oligos, and the set of oligos corresponding to the subunits of the data unit may be reassembled into the original data unit. An example oligo format 140, including primers 142 and 148 that may be added to support the PCR amplification and sequencing, may include a payload 144 comprising a subunit of the data unit, a redundancy portion 146 for error correction code (ECC) data for that subunit, and an address portion 150 for determining the sequence of the payloads for reassembling the data block. In some configurations, Reed-Solomon error correction codes may be used to determine the redundancy portion 146 for payload 144.

At block 160, DNA base data signals may be read from the sequenced DNA. For example, the analog signal from the nanopore reader may be conditioned (equalized, filtered, etc.) and converted to a digital data signal for each oligo.

At block 162, multiple copies of the oligos may be determined. Through the amplification process, multiple copies of each oligo may be produced, and the decoding system may determine groups of the same oligo to process together.

At block 164, each group of the same oligo may be aligned and consensus across the multiple copies may be determined. For example, a group of four copies may be aligned based on their primers, and each base position along the set of base values may have a consensus algorithm applied to determine a most likely version of the oligo for further processing, such as, where 3 out of 4 agree, that value is used.

At block 166, the primers may be detached. For example, primers 142 and 148 may be removed from the set of data corresponding to payload data 144, redundancy data 146, and address 150.

At block 168, error checking may be performed on the resulting data set. For example, ECC processing of payload 144 based on redundancy data 146 may allow errors in the resulting consensus data set for the oligo to be corrected. The number of correctable errors may depend on the ECC code used. ECC codes may have difficulty correcting errors created by insertions or deletions (resulting in shifts of all following base values). The size of the oligo payload 144 and portion allocated to redundancy data 146 may determine and limit the correctable errors and efficiency of the data format.

At block 170, the bases or base symbols may be inversely mapped back to the original bit data. For example, the symbol encoding scheme used to generate the DNA code may be reversed to determine corresponding sequences of bit data.

At block 172, a file or similar data unit may be reassembled from the bit data corresponding to the set of oligos. For example, address 150 from each oligo payload may be used to order the decoded bit data and reassemble the original file or other data unit.

FIG. 2 shows an improved DNA storage system 200 and, more specifically, an improved encoding system 210 and decoding system 240 for using multistage error correction using reference marks and soft information consensus to correct for insertion/deletion errors and other error correction techniques to address mutation and/or erasure errors. In some configurations, encoding system 210 may be part of a first computer or storage system or device used for determining target binary data, such as a conventional binary data unit, and converting it to a DNA base sequence for synthesis into DNA for storage, and decoding system 240 may be part of a second computer or storage system or device used for receiving the data signal corresponding to the base sequence read from the DNA.

Encoding system 210 may include a processor 212, a memory 214, and a synthesis system interface 216. For example, encoding system 210 may be part of a computer or storage system or device configured to receive or access conventional computer data, such as data stored as binary files, blocks, data objects, databases, etc., and map that data to a sequence of DNA bases for synthesis into DNA storage units, such as a set of DNA oligos. Processor 212 may include any type of conventional processor or microprocessor that interprets and executes instructions. In some configurations, processor 212 may include a plurality of processors or processor cores configured to operate alone or in combination to execute one or more functions or sets of instructions described with regard to the other components of encoding system 210. Memory 214 may include a random-access memory (RAM) or another type of dynamic storage device that stores information and instructions for execution by processor 212 and/or a read only memory (ROM) or another type of static storage device that stores static information and instructions for use by processor 212. In some configurations, one or more components of encoding system 210 may be embodied in specialized logic and memory circuits configured for the functions described for encoding system 210 and may incorporate or operate in conjunction with processor 212 and memory 214. For example, one or more encoders, formatters, and/or insertion functions may be embodied in a specialized encoder circuit, such as a system on a chip (SOC), field programmable gate array (FPGA), application specific integrated circuit (ASIC), or similar circuit configuration, that may be configured to operate alone or in combination with other specialized circuits and/or processor 212 and memory 214. Encoding system 210 may also include any number of input/output devices and/or interfaces. Input devices may include one or more conventional mechanisms that permit an operator to input information to encoding system 210, such as a keyboard, a mouse, a pen, voice recognition and/or biometric mechanisms, etc. Output devices may include one or more conventional mechanisms that output information to the operator, such as a display, a printer, a speaker, etc. Interfaces may include any transceiver-like mechanism that enables encoding system 210 to communicate with other devices and/or systems. For example, synthesis interface 216 may include a connection to an interface bus (e.g., peripheral component interconnect express (PCIe) bus) or network for communicating the DNA base sequences for storing the data to a DNA synthesis system. In some configurations, synthesis interface 216 may include a network connection using internet or similar communication protocols to send a conventional data file listing the DNA base sequences for synthesis, such as the desired sequence of bases for each oligo to be synthesized, to the DNA synthesis system. In some configurations, the DNA base sequence listing may be stored to conventional removable media, such as a universal serial bus (USB) drive or flash memory card, and transferred from encoding system 210 to the DNA synthesis system using the removable media.

In some configurations, a series of processing components 218 may be used to process the target binary data, such as a target data file, data block, or other data unit, into the DNA base sequence listing for output to the synthesis system. For example, processing components 218 may be embodied in encoder software and/or hardware encoder circuits. In some configurations, processing components 218 may be embodied in one or more software modules stored in memory 214 for execution by processor 212. Note that the series of processing components 218 are examples, and different configurations and ordering of components may be possible without materially changing the operation of processing components 218. For example, in an alternate configuration, additional data processing, such as a data randomizer to whiten the input data sequence, may be used to preprocess the data before encoding. In another configuration, user data from a target data unit may be divided across a set of oligos according to oligo payload size or other data formatting prior to applying any encoding or synchronization (or sync) marks may be added after ECC encoding. Other variations are possible.

In some configurations, processing the target data may begin with a run length limited (RLL) encoder 220. RLL encoder 220 may modulate the length of stretches in the input data. RLL encoder 220 may employ a line coding technique that processes arbitrary data with bandwidth limits. Specifically, RLL encoder 220 may bound the length of stretches of repeated bits or specific repeating bit patterns so that the stretches are not too long or too short. By modulating the data, RLL encoder 220 can reduce problematic data sequences that could create additional errors in subsequent encoding and/or DNA synthesis or sequencing. In some configurations, RLL encoder 220 or a similar data modulation component may be configured to modulate the input data to ensure that data patterns used for syntax references do not appear elsewhere in the user data encoded in the oligo.

In some configurations, symbol encoder 222 may include logic for converting binary data into symbols based on the four DNA bases (adenine (A), cytosine (C), guanine (G), and thymine (T)). In some configurations, symbol encoder 222 may encode each bit as a single base pair, such as 1 mapping to A or T and 0 mapping to G or C. In some configurations, symbol encoder 222 may encode two-bit symbols into single bases, such as 11 mapping to A, 00 mapping to T, 01 mapping to G, and 10 mapping to C. More complex symbol mapping can be achieved based on multi-base symbols mapping to correspondingly longer sequences of bit data. For example, a two-base symbol may correspond to 16 states for mapping four-bit symbols, or a four-base symbol may map the 256 states of byte symbols. Multi-base pair symbols could be preferable from an oligo synthesis point of view. For example, synthesis could be done not on base pairs but on larger blocks, like ‘bytes’ correlating to a symbol size, which are prepared and cleaned up earlier (e.g., pre-synthesized) in the synthesis process. This may reduce the amount of synthesis errors. From an encoder/decoder point of view, these physically larger blocks could be treated as symbols or a set of smaller symbols.

In some configurations, data encoder 224 may include logic for encoding the user data unit using one or more error correction schemes and may encode user data units across multiple oligos. For example, encoding system 210 may use low-density parity check (LDPC) codes constructed for the oligo size and/or larger codewords than can be written to a single oligo. In some configurations, data across multiple oligos may be aggregated to form the desired codewords. Similarly, parity or similar redundancy data may not need to be written to each oligo and may instead be written to only a portion of the oligos or written to separate parity oligos that are added to the oligo set for the target data unit. In some configurations, ECC encoding may then be nested for increasingly aggregated sets of oligos, where each level of the nested ECC corresponds to increasingly larger codewords comprised of more oligos. Encoding system 210 may include one or more oligo aggregators and corresponding iterative encoders. For example, single level ECC encoding may use first level oligo aggregator and first level iterative encoder for codewords of 200-400 oligos. A two-level encoding scheme would use first and second level oligo aggregators for and corresponding first and second level iterative encoders, such as for 200 oligo codewords at the first level and 4000 oligo codewords at the second level.

Data encoder 224 may append one or more parity bits or similar redundancy data to the sets of codeword data for later detection whether certain errors occur during data reading process. For instance, an additional binary bit (a parity bit) may be added to a string of binary bits that are moved together to ensure that the total number of “1”s in the string is even or odd. The parity bits may thus exist in two different types: an even parity in which a parity bit value is set to make the total number of “1”s in the string of bits (including the parity bit) to be an even number, and an odd parity in which a parity bit is set to make the total number of “1”s in the string of bits (including the parity bit) to be an odd number. In some examples, data encoder 224 may implement a linear error correcting code, such as LDPC codes or other turbo codes, to generate codewords that may be written to and more reliably recovered from the DNA medium. In some configurations, resulting parity or similar redundancy data may be stored in parity oligos designated to receive the redundancy data for the set of oligos that make up the codeword data. This additional parity data may be encoded using RLL encoder 220, symbol encoder 222, oligo formatter 226, and/or reference mark logic.

In some configurations, oligo formatter 226 may include logic for allocating portions of the target data unit to a set of oligos. For example, oligo formatter 226 may be configured for a predetermined payload size for each oligo and select a series of symbols corresponding to the payload size for each oligo in the set. In some configurations, the payload size may be determined based on an oligo size used by the synthesis system and any portions of the total length of the oligo that are allocated to redundancy data, address data, reference mark data, or other data formatting constraints. For example, a 150 base pair oligo using two-base symbols may include an eight-base addressing scheme and six four-base sync marks, resulting in 118 base pairs of the target data allocated to each oligo. In some configurations, oligo formatter 226 may insert a unique oligo address or oligo index (including the oligo address) for each oligo in the set, such as at the beginning or end of the data payload. The oligo address may allow the encoding and decoding systems to identify the data unit and relative position of the symbols in a particular oligo relative to the other oligos that contribute data to that data unit. For example, decoding system 240 may use position information corresponding to the oligo addresses to reassemble the data unit from a set of oligos in an oligo pool containing one or more data units. In some configurations, rather than including the oligo index in a data sequence separate from the user data payload, such as a header or footer of the oligo data, the oligo index may be embedded or encoded in the reference marks distributed through the data payload. This may allow the reference marks to double as oligo index space, reducing overall data overhead, and allow for redundant copies of the oligo index to be more reliably encoded in the oligo.

In some configurations, oligo index formatter 228 may include logic to assemble the oligo index data to be included in the oligo. In prior oligo data formats, oligo index formatter 228 may operate as part of oligo formatter 226 to collect and format the oligo index data for the sequence of base pairs that would store the index, such as a specific set of base pairs within the oligo header. In configurations that embed the oligo index in a distributed fashion, such as embedded within the sequence of reference marks, oligo index formatter 228 may operate separately from oligo formatter 226 to conform with the reference mark format determined by reference mark encoder 230, reference mark formatter 232, and reference mark inserter 234. Oligo index formatter 228 may determine a sequence or set of base pairs that correspond to the oligo index data, such as the oligo address, one or more other syntactical parameters, and/or encoding specific to the oligo index (e.g., oligo index cyclic redundancy check (CRC) or parity bits). In some configurations, the oligo index data may include only the oligo address, with or without redundancy data. The set of data for the oligo index may include an oligo address value of a predetermined bit length to provide unique addresses to the set of oligos in a DNA oligo pool. In some configurations, the oligo index value may be mapped or translated into a set of reference patterns for encoding in the reference marks of the oligo. For example, one or more reference patterns may be mapped to oligo address values, with or without additional redundancy data, such that the selected reference pattern encodes the oligo address.

In some configurations, reference mark encoder 230 may include logic for determining a pattern of values to be used for reference marks. For example, a series of base pairs placed at rigid, predetermined intervals or frequency may conform to a known sequence for detecting the presence of the reference marks interspersed with user data over the length of the oligo. In some configurations, each reference mark may be a single base pair and, thus, would not be inherently distinguishable from user data encoded using that base pair. However, when aggregated across a series or set of reference marks, the reference marks may be identified as syntactic reference pattern separate from the user data they provide a reference for. By using a rigid and predetermined interval or frequency of a fixed number of user data base pairs between reference mark base pairs, a pattern similar to the timing structure used in the reading and writing of moving media, such as rotating magnetic/optical disks or linear magnetic tapes, may be established. In some configurations, similar encoding and logics from timing marks in moving media may be used for reference marks. For example, a convolutional code, including hash encoded decoded by greedy exhaustive search (HEDGES) ECC, that is configured for detection and recovery across a series of reference marks may be selected. In some configurations, reference mark encoder 230 may include a cyclic redundancy check (CRC) code that may be used to verify the sequence in the reference marks during the decoding process. In some configurations, reference mark encoder 230 may select or assemble reference patterns from a reference set 238 that includes a fixed set of known or predetermined reference patterns or reference pattern segments (e.g., each reference pattern or reference pattern segment corresponding to a unique convolutional code instance) that provide detectable patterns for reestablishing the data frequency during decoding without unduly increasing the error rates in DNA synthesis.

In some configurations, reference mark encoder 230 may operate on the oligo index data set received from oligo index formatter 228. For example, the oligo index data may be modulated and encoded using a convolutional code to be reliable distinguished from the user data as reference marks during decoding. That is, the oligo index data may form the basis of the reference mark pattern and reference mark encoder 230 may be configured to receive and encode the oligo index data set for generation of the reference marks. In some configurations, the oligo index data may be mapped, with or without redundancy data, to reference pattern segments selected from reference set 238. Reference mark encoder 230 may provide the oligo address encoded as a series of reference pattern segments to reference mark formatter 232 for determining the configuration of the multiple reference pattern segments to be stored across the reference marks.

In some configurations, reference mark formatter 232 may include logic for formatting reference marks for insertion at predetermined intervals among the data symbols. For example, reference marks may be inserted every X base pairs to divide the data in the oligo into a predetermined number of shorter data segments with a timing frequency of 1/X and a resulting code rate of 1/(X+(base pairs in each reference mark)). In some configurations, each reference mark may comprise a single base pair as described for reference mark encoder 230 for a code rate of 1/(X+1). In some configurations, a code rate of 0.5 (1/(1+1), alternating a base pair of user data with a base pair reference mark) may be selected to provide a desired likelihood of reference recovery and a high likelihood of identifying and correcting insertion and deletion errors to return the user data to a desired timing/data pattern with only mutation and/or erasure errors to be addressed through user data ECC. In an example configuration, an oligo may have a payload space of 140 base pairs, and formatting the reference marks at a 0.5 code rate would result in 70 base pairs of user data alternating with 70 base pairs of reference marks. The predetermined sequence and frequency of the reference marks may be used during the decoding process to determine and evaluate user data segments within an oligo to better detect and localize insertions and deletions that are difficult for error correction codes to detect or correct. For example, decoding system 240 may detect reference marks and correct symbol alignment prior to attempting iterative decoding with ECC. Use of reference marks is further described below with regard to decoding system 240.

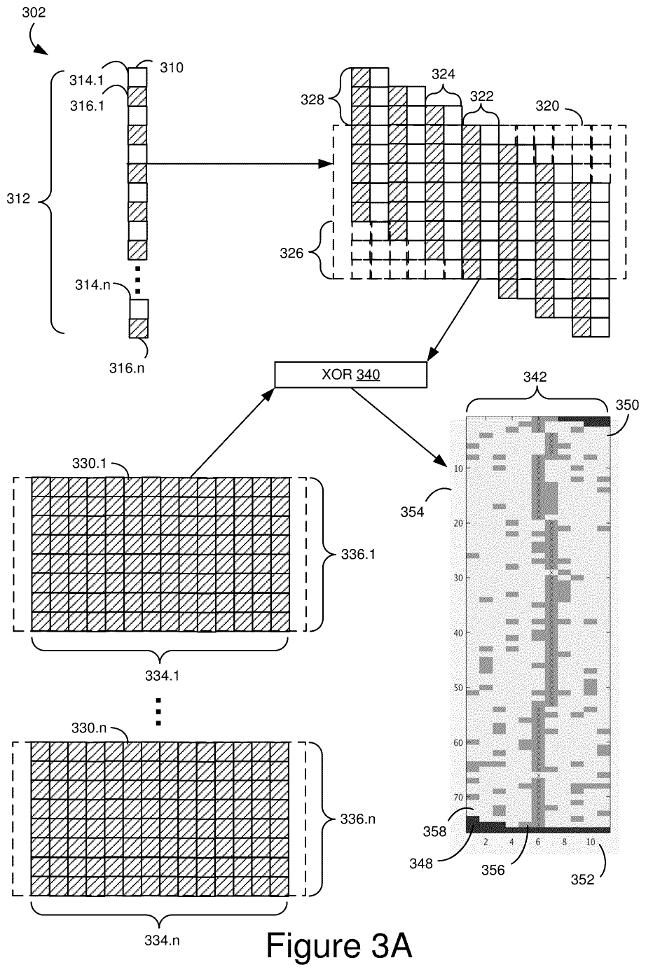

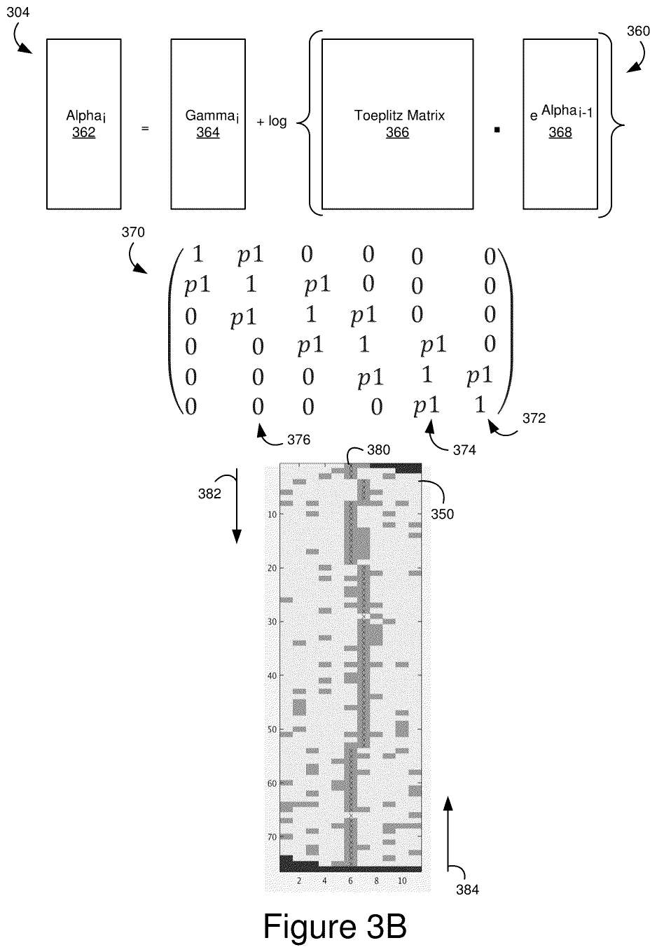

Reference mark formatter 232 may be configured to determine the number of reference pattern segments and configuration of those segments in the encoded reference pattern. For example, where the reference pattern is based on assembling a plurality of reference pattern segments, reference mark formatter 232 may determine the number of copies and the positions and/or translations of those segments across the reference marks. As shown in FIG. 3A, an example set of oligo data 310 may include user data base pairs 314.1-314.n alternating with reference mark base pairs 316.1-316.n. In the example shown, the oligo index comprises a base pair sequence 312 with a predetermined length for encoding user data alternating with reference marks. The sequence of reference marks 316.1-316.n may include a single reference pattern or a sequence of reference pattern segments assembled into a larger reference pattern. In some configurations, one or more reference pattern segments may be used to encode the oligo index or oligo address.

In some configurations, reference mark inserter 234 may include logic to insert the sequence of reference marks into the user data for determining the DNA sequence to be synthesized. For example, reference mark inserter 234 may operate according to the frequency configured in reference mark formatter 232 to insert the sequence of base pairs determined by reference mark encoder 230 and ordered copies from reference mark formatter 232 between corresponding portions of the user data. In the example using a code rate of 0.5, reference mark inserter 234 may alternate selecting a next base pair from the encoded user data with a next base pair from the reference marks to interleave single base pairs of user data with single base pair reference marks. In other configurations, a single base pair reference mark may be inserted after a plurality of user data base pairs, such as a larger (multi-base pair) symbol or segment size.

The resulting DNA base pair sequence corresponding to the encoded target data unit may be output from processing components 218 as DNA data 236. For example, the base pair sequences for each oligo in the set of oligos corresponding to the target data unit may be stored as sequence listings for transfer to the synthesis system. In some configurations, the base pair sequences may include the encoded data unit data formatted for each oligo, including address, sync mark, and redundancy data added to the user data for the data unit. The set of oligos may include a plurality of first level codeword sets and their corresponding parity oligos and, in some configurations, nested groups of first level codeword sets, second level codeword sets, and so on for as many levels as the particular recovery configuration supports.

Decoding system 240 may include a processor 242, a memory 244, and a sequencing interface 246. For example, decoding system 240 may be part of a computer or storage system or device configured to receive or access analog and/or digital signal read data from reading sequenced DNA, such as the data signals associated with a set of oligos that have been amplified, sequenced, and read from stored DNA media. Processor 242 may include any type of conventional processor or microprocessor that interprets and executes instructions. In some configurations, processor 242 may include a plurality of processors or processor cores configured to operate alone or in combination to execute one or more functions or sets of instructions described with regard to the other components of decoding system 240. Memory 244 may include a random-access memory (RAM) or another type of dynamic storage device that stores information and instructions for execution by processor 242 and/or a read only memory (ROM) or another type of static storage device that stores static information and instructions for use by processor 242. In some configurations, one or more components of decoding system 240 may be embodied in specialized logic and memory circuits configured for the functions described for decoding system 240 and may incorporate or operate in conjunction with processor 242 and memory 244. For example, one or more encoders, formatters, and/or insertion functions may be embodied in a specialized decoder circuit, such as a system on a chip (SOC), field programmable gate array (FPGA), application specific integrated circuit (ASIC), or similar circuit configuration, that may be configured to operate alone or in combination with other specialized circuits and/or processor 212 and memory 214. Decoding system 240 may also include any number of input/output devices and/or interfaces. Input devices may include one or more conventional mechanisms that permit an operator to input information to decoding system 240, such as a keyboard, a mouse, a pen, voice recognition and/or biometric mechanisms, etc. Output devices may include one or more conventional mechanisms that output information to the operator, such as a display, a printer, a speaker, etc. Interfaces may include any transceiver-like mechanism that enables decoding system 240 to communicate with other devices and/or systems. For example, sequencing interface 246 may include a connection to an interface bus (e.g., peripheral component interconnect express (PCIe) bus) or network for receiving analog or digital representations of the DNA sequences from a DNA sequencing system. In some configurations, sequencing interface 246 may include a network connection using internet or similar communication protocols to receive a conventional data file listing the DNA base sequences and/or corresponding digital sample values generated by analog-to-digital sampling from the sequencing read signal of the DNA sequencing system. In some configurations, the DNA base sequence listing may be stored to conventional removable media, such as a universal serial bus (USB) drive or flash memory card, and transferred to decoding system 240 from the DNA sequencing system using the removable media.

In some configurations, a series of processing components 248 may be used to process the read data, such as a read data file or read data signal from a DNA sequencing system, to output a conventional binary data unit, such as a computer file, data block, or data object. For example, processing components 248 may be embodied in decoder software and/or hardware decoder circuits. In some configurations, processing components 248 may be embodied in one or more software modules stored in memory 244 for execution by processor 242. Note that the series of processing components 248 are examples and different configurations and ordering of components may be possible without materially changing the operation of processing components 248. For example, in an alternate configuration, additional data processing for reversing modulation or other processing from encoding system 210 and/or reassembly of decoded oligo data into larger user data units may be included. Other variations are possible.

Decoding system 240 may use a first stage of error correction targeting the elimination of insertion and deletion errors (which create shifts in all following base pairs in a sequence), followed by ECC error correction to address mutation or erasure errors. In some configurations, consensus correction may be used in the first stage to assist with reference mark timing and insertion/deletion correction and, more specifically, to use consensus correction for replacing base pairs lost in deletion errors (rather than just marking them as erasures). DNA media and sequencing face three main types of errors: deletion, insertion, and mutation. Mutation errors are most similar to the traditional errors in data storage and may efficiently be handled using ECC correction. Insertion and deletion errors affect the position of all following bits or symbols and may not be effectively handled by ECC. Therefore, preprocessing the oligo sequences for sequence position shifts and, where possible, correcting those position shifts may contribute to more efficient and reliable data reading. The preprocessing stage may reduce the error rate in the oligo sequences significantly prior to applying ECC correction, enabling more efficient ECC codes and more reliable retrieval of data using a first level of ECC encoding in nested ECC configurations. In some configurations, the preprocessing stage may include reference mark decoder 250, insertion/deletion correction 252, erasure identifier 254, oligo index decoder 256, oligo set sorter 258, and data consensus correction 260.

In some configurations, reference mark decoder 250 may include logic for comparing read data for an oligo to a plurality of different reference matrices to determine the most likely reference pattern for detecting and correcting insertions and deletions based on reference marks with a known frequency. For example, the read data may be processed through multiple attempts to determine a most likely path through correlation matrices corresponding to different possible reference patterns from reference set 238, and resulting scoring from those attempts may be used to select the most likely reference pattern to use for reference mark decoding and timing correction. In some configurations, reference mark decoder 250 may be configured to operate on a single copy of oligo read data and reliably determine the set of reference marks using a correlation matrix to align the possible reference marks and multiple copies of each reference pattern to determine the reference pattern that maximizes the quality of the timing information. As shown in FIG. 3A, a series of operations 302 may generate and populate a correlation matrix based on oligo read data 310. In some configurations, read data 310 may be used to generate a convolutional matrix 320. Convolutional matrix 320 may be based on filtering and stacking reference mark positions 316.1-316.n and user data positions 314.1-314.n from the read data to make alternating columns of the respective base pairs. In the example shown, one base pair of reference marks alternates with one base pair of user data, so filtering may be based on selecting the odd positions as user data values and the even positions as reference mark values. Each column includes a number of base pairs representing the user data portion or the reference mark portion of the oligo (e.g., half the length of the oligo for each type). The center pair of columns 322 comprise the full set of reference mark base pairs and user data base pairs. Each pair of columns in either direction is then offset by one row or base pair of that type (though this represents a two base pair offset when both reference marks and user data are considered). For example, columns 324 are offset by one row from columns 322. Where no read values are available due to the offset of the read data, placeholders 326 may be added. These are null values that are not valid portions of convolutional matrix 320 for subsequent calculations. Similarly, read data values 328 that fall outside of convolutional matrix 320 are not represented in the matrix and are shown merely for illustrating the data shift. The resulting convolutional matrix includes rows corresponding to pairs of positions along the oligo, and the columns correspond to single base pair offsets that, if no insertion or deletion errors were present, would alternate between reference mark base pairs and user data base pairs.

In some configurations, reference set 238 may include a set of unique and predetermined or fixed reference patterns used to encode the reference marks for each oligo. At this point in the processing, which reference pattern was used for the particular oligo may be unknown, and reference mark decoder 250 may sequentially attempt each reference pattern to determine which of the reference patterns was used to encode the reference marks. For example, reference set 238 may include 16 or more different reference patterns. In some configurations, reference set 238 may include reference pattern segments that may be processed in combinations and/or repeated in a plurality of positions to form the larger reference pattern. For example, 256 reference pattern segments may support different positions in the combined reference pattern that encodes an oligo index in addition to providing reference marks for error correction. Reference mark decoder 250 may use a series of reference matrices 330.1-330.n each corresponding to the different reference patterns in reference set 238. Unlike convolutional matrix 320, reference matrices 330 are constructed without offset. Each column 334.1-334.n repeats the reference pattern set of base pairs in reference matrix 330.1-330.n. Each row 336.1-336.n includes the same base pair values corresponding to that position in the reference pattern.

A series of exclusive-or (XOR) operations 340 may then be used to compare each base pair in convolutional matrix 320 with the corresponding matrix position in reference matrices 330.1-330.n. The results of these comparisons may populate a correlation matrix 350 with binary logical matrix values 342. The x-axis 352 denotes the columns of the correlation matrix. The central reference mark column from convolutional matrix 320 corresponds to 0 offset, and each column to the left or right corresponds to a one base pair offset in that direction. In the example shown, a band of 5 offset positions in each direction is being used, with 6 being the nominal (encoded) position of the reference marks, 1 being a 5 base pair shift generally corresponding to the direction of deletions, and 11 being a 5 base pair shift generally corresponding to the direction of insertions. The y-axis 354 denotes the rows of the correlation matrix and corresponds to reference mark positions along the oligo. Medium gray positions, such as block 356, correspond to a 0 value or base pair matches from the XOR comparison. Light gray positions, such as block 358, correspond to a 1 value or base pair mismatches from the XOR comparison. Dark gray positions in the corners of the matrix, such as block 348, correspond to the placeholder or null values that are outside the valid positions of the matrix (created by the data shifts in convolutional matrix 320). Correlation matrix 350 may be used to determine the most likely positions of insertions and deletions based on shifts in the matching values by one or more columns in each direction, as well as determining which of the reference patterns provides the best results and most likely reference pattern to use. Note that while convolutional matrix 320 and reference matrices 330.1-330.n are graphically illustrated with a small number of oligo positions, example correlation matrix 350 is based on a more common oligo size of 150 base pairs, yielding 75 base pair positions corresponding to reference marks at a 0.5 code rate.

As shown in FIG. 3B, a sequence of operations 304 may use a Viterbi-like algorithm 360 to analyze correlation matrix 350 and identify the most likely path through the sequence of reference positions. The algorithm applies one or more traverses of the rows of correlation matrix 350 to determine whether the reference position has shifted due to an insertion or deletion. In some configurations, algorithm 360 is a recursive Viterbi algorithm that uses the probability determined for a prior value in the matrix to determine the probability of the next value in the matrix in the direction of the traversal. Alphaᵢ values 362 may include a set of values corresponding to the next row in correlation matrix 350 to be analyzed. Gammaᵢ values 364 may correspond to a set of values for the column shift or offset of the next row. The offset values may be modified by a probabilistic term based on the log of the exponential function of the prior Alpha values 368 (e^{Alpha}ᵢ₋₁) multiplied by a Toeplitz matrix 366. Toeplitz matrix 366 represents the probabilities of moving from one column to the other (insertions or deletions shifting reference mark alignment) and limits the probable movements to a desired range. An example Toeplitz matrix 370 comprises a central diagonal 372 corresponding to no shift and represented by constant values of 1. The p1 values 374 correspond to a one position shift in either direction. The p1 value may be selected to represent a likelihood of position shift. For example, a p1 value may be 0.03 for one position shift in each direction.

The output of Viterbi algorithm 360 may be a set of probabilities for each row, with the highest or maximum probability value indicating the most likely shift or offset for that position (or no shift/offset if the highest probability corresponds to the central reference mark column). In the example shown, indicator (x) 380 in each row corresponds to the column selected for that row as the most likely shift value based on the highest probability value for that row. In some configurations, Viterbi algorithm 360 may be evaluated in multiple directions and summed or averaged to determine the most likely values for each reference position (row). For example, a first direction 382 may correspond to traversing correlation matrix 350 from the top row (first reference mark position in the oligo) to the bottom row (last reference mark position in the oligo). A second direction 384 may correspond to traversing correlation matrix 350 in the reverse or opposite direction from the bottom row (last reference mark position in the oligo) to the top row (first reference mark position in the oligo). The results from the two traversals may then be summed or otherwise evaluated to determine the most likely shift for each reference mark position. The resulting summation (or a single traversal if that is all that is used) results in probability values for each entry in the correlation matrix that may be referred to as soft information from the Viterbi algorithm traversal of the correlation matrix.

In some configurations, a compare function of reference mark decoder 250 may execute Viterbi algorithm 360 for each reference pattern in reference set 238 and corresponding reference matrices 330.1-330.n and calculate scores for each reference pattern. For example, the sum of columns may provide a relative likelihood value for that reference pattern. These Viterbi scores for each reference pattern may be compared, and the maximum value may indicate the most likely reference pattern. In some configurations, Viterbi scores may be calculated for each reference pattern segment, and corresponding sets of positions in the larger reference pattern and scores compared for each set of positions to determine the most likely reference pattern segment for that position. The resulting most likely reference pattern may be based on the ordered set of reference pattern segments that maximized their respective segment positions. In some configurations, Viterbi normalization may be modified for the comparison of the different reference patterns. For example, the Viterbi scores may not be normalized for each column to improve the comparison of different reference matrices. In some configurations, the Viterbi algorithm 360 may be executed iteratively in response to adjustments made to correct insertions and deletions until reference timing may be restored or the reference timing is determined to be unrecoverable. In some configurations, the Viterbi scores for the different reference patterns may be compared to one another, as well as to a threshold value for acceptable decoding. Based on the most likely reference pattern selected, the output of that correlation matrix and Viterbi analysis may be used for subsequent detection and correction of erasure errors to reestablish the timing of the selected reference pattern.

In some configurations, insertion/deletion correction 252 includes logic for selectively correcting the insertion and deletion errors in an oligo, where possible. For example, insertion/deletion correction 252 may use the output from reference mark decoder 250 to determine correctable insertion/deletion errors. For example, where an insertion or deletion error has occurred between sync marks, the position of subsequent segments may be corrected for the preceding shift in base pair positions to align the symbols in segments without insertions/deletions with their expected positions in the oligo. In some configurations, reference mark decoder 250 may enable insertion/deletion correction 252 to specifically identify likely locations of insertion and/or deletion errors at the base pair level due to the 0.5 code rate. In some configurations, insertion deletion correction 252 may be used following data consensus correction 260 where oligo copies are known. This may be the result of a first pass through oligo index decoder 256 and oligo set sorter 258 based on single copy data and/or where copies are sorted based on data that is not encoded in the reference marks.

In some configurations, erasure identifier 254 may flag segments of base pairs in the oligo as erasures in need of ECC error correction. For example, reference mark decoder 250 and related analysis may determine one or more base pairs between sync marks to be identified as erasures for error correction and/or data consensus correction 260. In some configurations, signal quality, statistical uncertainty, and/or specific thresholds for consensus may cause erasure identifier 254 to identify one or more segments as erasures because the processing by reference mark decoder 250 and/or data consensus correction 260 is inconclusive. For example, erasure identifier 254 may be configured to output an oligo that has had as many base pairs or symbols as possible positively identified as not containing insertion or deletion errors and identify (and localize) as erasures any base pairs that cannot be determined to be free of insertion or deletion errors prior to performing ECC error correction. Most commonly, placeholders inserted for identified deletions to restore reference mark timing may be identified as erasures. Note that mutation errors in DNA storage may be equivalent to the erasure errors ECC are configured to correct and need not be identified in the preprocessing stage. In some configurations, the insertion/deletion corrected output oligo base pair sequence and related erasure tags and/or soft information from reference mark decoder 250 may be the output of the preprocessing stage of decoding system 240.

In some configurations, the reference marks may also be configured to encode the oligo index in the reference pattern. For example, the reference marks may include a plurality of reference pattern segments that encode the oligo index value for the oligo index. In these configurations, the most likely reference pattern may be passed to oligo index decoder 256. Oligo index decoder 256 may include logic to determine the oligo index from the reference marks distributed through the oligo read data. For example, the read data for each oligo may include reference marks interspersed with the user data, and the oligo index data may be encoded in one or more sequences of the reference marks. In some configurations, the oligo index may be encoded using correlation to one or more reference patterns in the reference marks. For example, reference set 238 may include reference pattern segments that map to bit values for encoding the oligo address. In some configurations, the oligo address is segmented into multiple oligo address portions that are each encoded using different reference patterns. The series of reference pattern segments from the most likely reference pattern may be used to determine the corresponding oligo address segments. Those oligo address segments may then be reassembled into the oligo address. In some configurations, the oligo address and/or oligo address segments may include redundancy data. Oligo index decoder 256 may perform a redundancy check to determine whether the integrity of each oligo address segment and/or the oligo address as a whole is intact. If the redundancy check fails, operation may return to reference mark decoder, the oligo may be determined to be unreadable, or other error correction processing may be initiated. In some configurations, a CRC check may also be used for oligo index data verification after the oligo index segments are assembled. Oligo index decoder 256 may be configured to only return oligo index data with a high-level of confidence for use in further processing of the oligo read data.

In some configurations, oligo set sorter 258 may include logic to sort a received group of oligo data sequences into sets of copies. For example, the DNA amplification process may result in multiple copies of some or all oligos, and oligo set sorter 258 may sort the oligo data sequences into like sequences. Sorting may be based on tagging during the sequencing process, oligo address data (such as oligo address data from the oligo index decoder 256), and/or statistical analysis of sequences (or samples thereof) to determine repeat copies of each oligo. Note that different copies may include different errors and, at this stage, exact matching of all bases in the sequence may not be the sorting criteria. In this regard, each input oligo may generate a set of one or more oligo copies that correspond to the original input oligo data but may not be identical copies of that data or of one another, depending on when and how the errors were introduced (thus the need for error correction). Oligo set sorting to determine the number of multiple copies may be performed prior to stage one error correction and independent of the ability to successfully decode the oligo address if there are other indicators with sufficient reliability to sort the oligos. A set of oligo copies may be processed together, particularly through the first stage of processing, to determine or generate a best copy of the oligo for ECC processing. In some configurations, the best copy of the oligo may also be passed with the soft information aggregated from the multiple copies for use in ECC processing.

In some configurations, data consensus correction 260 may include logic for using comparison of multiple preprocessed copies and may include copies that have had their reference mark timing recovered to reduce the number of erasure errors and/or resolve inconclusive reference mark corrections. In some configurations, data consensus correction 260 may use consensus averaging based on soft information from reference mark decoder 250 rather than direct comparison of base pair values from the most likely paths of each copy. For example, correlation analysis across more than two copies of an oligo may allow statistical methods and soft information values to be compared to a correction threshold for deleting inserted base pairs, inserting padding or placeholder base pairs (which may be identified as erasures by erasure identifier 254), and/or correcting mutation errors that appear in a minority of copies. The correction threshold may depend on the number of copies being cross-correlated, decoder signal-to-noise ratio (SNR), size of the insertion/deletion event, a reliability value of the statistical method, and/or the error correction capabilities of the subsequent ECC processing, including any nested ECC. In some configurations, data consensus correction 260 may be included as part of the preprocessing stage of decoding system 240.

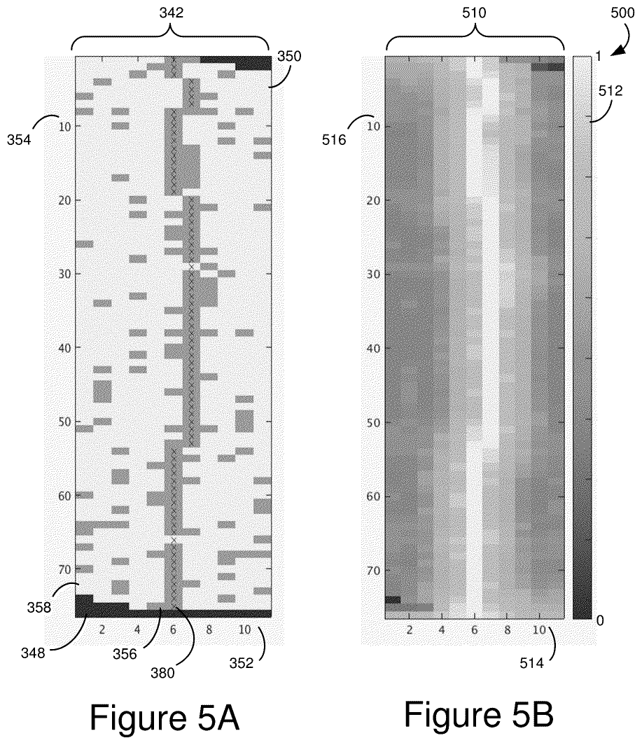

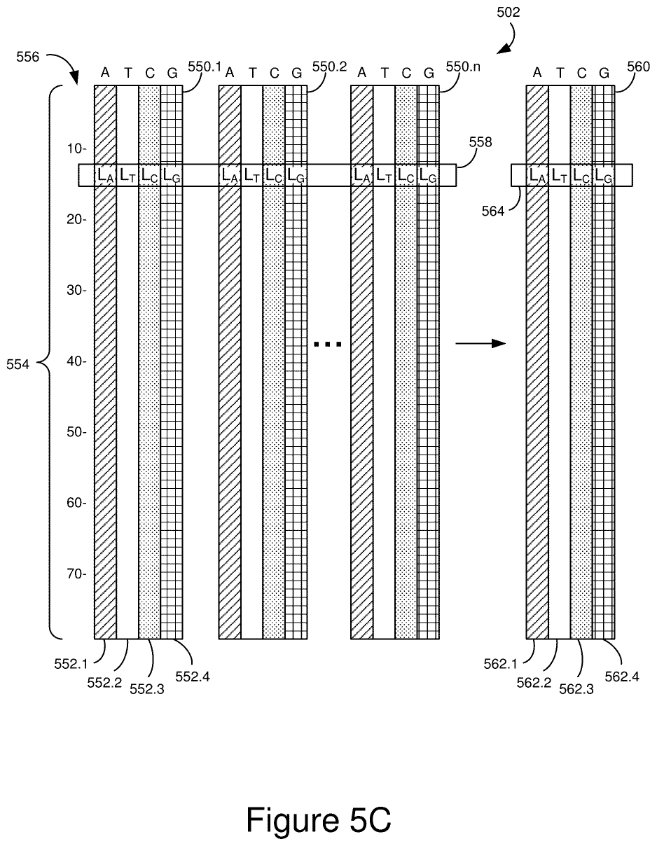

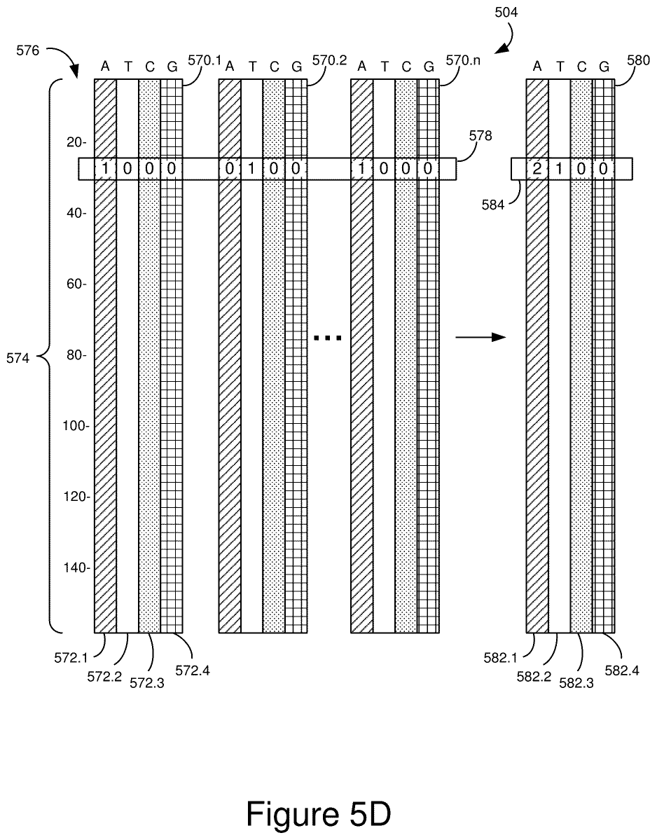

As shown in FIGS. 5A, 5B, and 5C, soft information from Viterbi algorithm processing of the correlation matrix from reference mark decoder 250 may be used for soft information consensus correction. For example, in FIG. 5A, correlation matrix 350 may be processed for each copy of the oligo with a resulting matrix of probability value entries that correlate to a most likely path 380 for that oligo copy. Correlation matrix 350 may correspond to the likelihood of position shifts based on the corresponding probability values being closer to 0 (medium gray entries 356) or 1 (light gray entries 358). However, the underlying probability values or soft information represent a larger spectrum of values. As shown in FIG. 5B, a soft value map 500 of correlation matrix 350 shows a wider range of gray-scale coded probability values 510. Soft information value map 500 may correspond to the matrix of probability values underlying correlation matrix 350. Scale 512 provides a gray-scale spectrum of probability values from 0 to 1 where the lightest gray value corresponds to a maximum likelihood value and the darkest gray value corresponds to a lowest likelihood value. Soft value map 500 is a way of visualizing the set of soft information from correlation matrix 350 and comprises the same matrix with position shifts on x-axis 514 and reference positions for the oligo on the y-axis. Note that the same type of correlation matrix and soft information map could be made for the full set of oligo positions, including both reference and oligo payload data.

FIG. 5C shows a set 502 of aggregate base pair probability values for multiple copies of the oligo. For example, the probability values from correlation matrix 350 may be mapped to a likelihood of each base pair for that position in the oligo. Each base pair matrix 550.1-550.n may include the probability of each base pair in each position aggregated across each row of correlation matrix 350. For example, each set of values 554 may include the likelihood of that base pair 552.1-552.4 at that position 556 (e.g., 1-80) along the length of the oligo. An example set of probability values (L_{A}, L_{T}, L_{C}, L_{G}) 558 for the likelihood at the same positions may be determined from correlation matrix 350 for each copy of the oligo. The sets of probability values for each base pair matrix 550.1-550.n may be aggregated into a consensus average matrix 560 that includes the aggregate value of each base pair 562.1-562.4 and positions 554 across the oligo copies. For example, the set of probability values 558 may then be aggregated into a consensus average set of values 564. The example base pair matrices are shown for reference mark positions, but similar base pair matrices could be constructed for all base pair positions in the oligo copies. In the example, shown, columns 552.1 and 562.1 correspond to the likelihood values for an A base pair at each oligo position, columns 552.2 and 562.2 correspond to the likelihood values for a T base pair at each oligo position, columns 552.3 and 562.3 correspond to the likelihood values for a C base pair at each oligo position, and columns 552.4 and 562.4 correspond to the likelihood values for a G base pair at each oligo position. Equivalent base pair matrices 550.1-550.n may be generated from corresponding correlation matrices for each copy of the oligo. These matrices and the soft information values they contain may be consensus averaged across the multiple copies to determine a most likely base pair value for each position along the length of the oligo as shown in consensus average matrix 560. For example, the maximum probability value among the possible base pairs for each base pair position may indicate the most likely base pair value. This may be selectively determined for the reference mark positions only or for all base pair positions.

FIG. 5D shows a set 504 of aggregate base pair hard decision values for multiple copies of the oligo. For example, the maximum likelihood from among the probability values from correlation matrix 350 may be mapped to a most likely base pair for that position in the oligo. Each base pair matrix 570.1-570.n may include a 1 or a 0 for each node depending on whether that base pair is the most likely base pair for that position along the oligo. For example, each set of values 574 may include a 1 for the base pair among base pairs 572.1-572.4 that is most likely at that position 576 (e.g., 1-160) along the length of the oligo. An example set of hard decision values 578 for the same positions may be determined from correlation matrix 350 for each copy of the oligo. The sets of probability values for each base pair matrix 570.1-570.n may be aggregated into a consensus average matrix 580 that includes the aggregate value of each base pair 582.1-582.4 and positions 574 across the oligo copies. For example, the set of hard decision values 578 may be aggregated into a consensus set of values 584. In some configurations, consensus average matrix 580 may further include division of the aggregate values by the number of copies to determine consensus average values that are probabilistic or soft information. For example, consensus set of values 584 based on three copies of the oligo may be represented as soft information by 0.66, 0.33, 0.0, and 0.0. The example base pair matrices are shown for all positions (reference and oligo payload data), but similar base pair matrices could be constructed for reference positions only in the oligo copies. In the example, shown, columns 572.1 and 582.1 correspond to the likelihood values for an A base pair at each oligo position, columns 572.2 and 582.2 correspond to the likelihood values for a T base pair at each oligo position, columns 572.3 and 582.3 correspond to the likelihood values for a C base pair at each oligo position, and columns 572.4 and 582.4 correspond to the likelihood values for a G base pair at each oligo position. Equivalent base pair matrices 550.1-550.n may be generated from corresponding correlation matrices for each copy of the oligo. Using hard decision matrices to generate aggregate soft information may be most valuable when there are greater than two copies of the oligo and the value of the consensus average from base pair hard decisions may increase in accuracy relative to the Viterbi soft information aggregates as the number of copies of the oligo increases. These matrices and the soft information values they contain may be consensus averaged across the multiple copies to determine a most likely base pair value for each position along the length of the oligo as shown in consensus average matrix 580. This may be selectively determined for the reference mark positions only or for all base pair positions.

In some configurations, data consensus correction 260 may be configured with multiple consensus functions based on different aggregations of soft information. For example, a first consensus function may be based on reference soft information 260.1, where the soft information for the correlation of reference mark positions is used across the multiple copies to determine the most likely path and corresponding base pair values for the reference mark positions. A second consensus function may be based on base pair soft information 260.2, where the soft information for the correlation of base pair hard decisions in the oligo is used across the multiple copies to determine the most likely path and corresponding base pair values for all positions. In some configurations, these different consensus functions may be selectively used based on the number of available copies. For example, a threshold value may be applied to the number of copies in the read data set where one consensus function (such as the reference consensus function) is more reliable at lower copy numbers. Data consensus correction 260 may apply the one consensus function to determining and correcting the reference mark base pairs with copy numbers below the threshold and apply another consensus function for determining and correcting the payload data base pairs if the threshold is met (or exceeded). In some configurations, multiple consensus functions may be applied to base pair consensus decisions. For example, the aggregate soft information from each consensus function may be selectively combined for making the most likely base pair decision. In some configurations, a weighting factor may be used to balance the relative contributions of the different consensus functions. For example, a weighting factor may be a ratio-based weighting value split between or among the consensus functions for determining the relative contributions of the aggregate soft information from the two or more functions for each position. In some configurations, the weighting factor may be variable based on the number of copies being used for the consensus determination. For example, at low numbers of copies, the reference mark consensus function may be weighted to contribute more to the likelihood decision and the ratio allocated to the full base pair or oligo payload consensus function may increase as the number of copies increases.

In some configurations, one or more iterative data decoders 262 may be configured to process the output from the preprocessing stage of decoding system 240. For example, a single “best guess” copy of each unique oligo in a set of oligos for a data unit, including erasure flags and/or soft information, may be passed from preprocessing to ECC decoding. In some configurations, reference marks, address fields, and other formatting data may be removed or ignored by decoding system 240 during ECC processing. Decoding system 240 may use one or more levels of ECC decoding based on aggregating the data from a number of oligos (unique oligos rather than copies of the same oligo). For example, decoding system 240 may use LDPC codes constructed for larger codewords than can be written to or read from a single oligo. Therefore, data across multiple oligos may be aggregated to form the desired codewords. Similarly, parity or similar redundancy data may not be retrieved from each oligo and may instead be read from only a portion of the oligos or from separate parity oligos in the oligo set for the target data unit. In some configurations, ECC decoding may then be nested for increasingly aggregated sets of oligos, where each level of the nested ECC corresponds to increasingly larger codewords comprised of more oligos. Decoding system 240 may include one or more oligo aggregators and corresponding iterative decoders. For example, single level ECC encoding may use first level oligo aggregator and first level iterative encoder for codewords of 200-400 oligos. A two-level encoding scheme would use first and second level oligo aggregators and corresponding first and second level iterative encoders, such as for 200 oligo codewords at the first level and 4000 oligo codewords at the second level.

In some configurations, iterative data decoders 262 may help to ensure that the states at the codeword satisfy the parity constraint by conducting parity error checking to determine whether data has been erased or otherwise lost during data read/write processes. It may check the parity bits appended by data encoder 224 during the data encoding process and compare them with the base pairs or symbols in the oligo sequences aggregated by the corresponding oligo aggregators. Based on the configuration of data encoder 224 in the data encoding process, each string of recovered bits may be checked to see if the “1”s total to an even or odd number for the even parity or odd parity, respectively. A parity-based post processor may also be employed to correct a specified number of the most likely error events at the output of the Viterbi-like detectors by exploiting the parity information in the coming sequence. In some configurations, iterative data decoder 262 may use soft information received from preprocessing to assist in decode decision-making. When decode decision parameters are met, the codeword may be decoded into a set of decoded base pair and/or symbol values for output or further processing by symbol decoder 264, RLL decoder 266, Cyclic Redundancy Check (CRC) 268, and/or other data postprocessing.

In some configurations, symbol decoder 264 may be configured to convert the DNA base symbols used to encode the bit data back to their bit data representations. For example, symbol decoder 264 may reverse the symbols generated by symbol encoder 222. In some configurations, symbol decoder 264 may receive the error corrected sequences from iterative data decoders 262 and output a digital bit stream or bit data representation. For example, symbol decoder may receive a corrected DNA sequence listing for one or more codewords corresponding to the originally stored data unit and process the corrected DNA sequence listing through the symbol-to-bit conversion to generate a bit data sequence.

In some configurations, RLL decoder 266 may decode the run length limited codes encoded by RLL encoder 220 during the data encoding process. In some configurations, the data may go through additional post-processing or formatting to place the digital data in a conventional binary data format. For example, CRC 268 may provide a simple and reliable way to check if the decoded codeword is correct or it is a near codeword. CRC 268 may be implemented as a division of the codeword on a primitive polynomial in some Galois field. The CRC value may be determined for each binary data unit and added by the originating system or encoding system 210. For example, the remainder of the division may be stored in the codeword information for the later CRC check after decoding. CRC 268 may be particularly advantageous for DNA storage, where error rate is high and near codeword detection is more probable. After a successful CRC check, the output data 270 may then be output to a conventional binary data storage medium, network, or device, such as a host computer, network node, etc. for storage, display, and/or use as a conventional binary data file or other data unit.

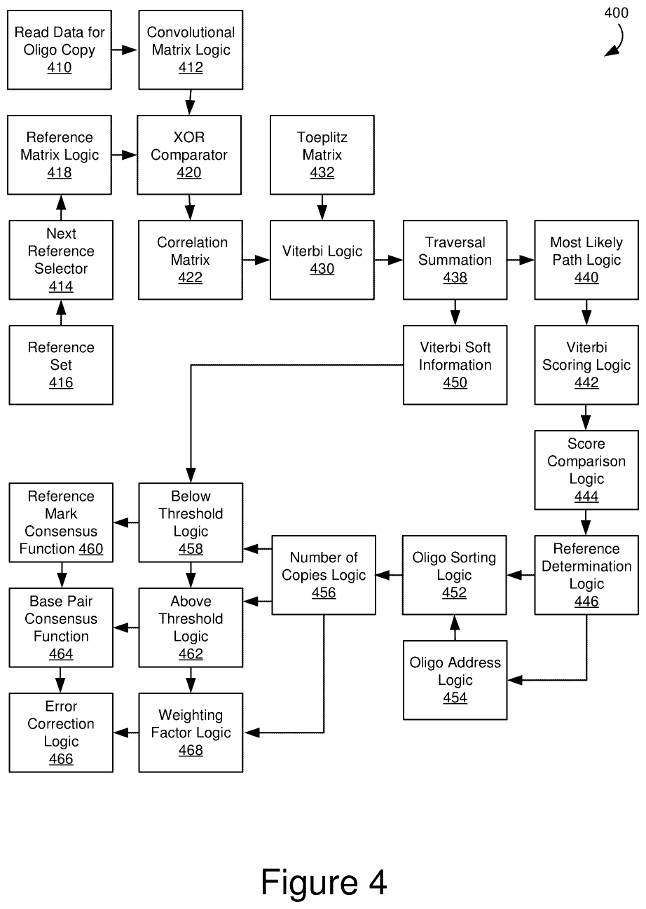

FIG. 4 includes an oligo data processing system 400 using soft information from multiple copies of an oligo for consensus correction of reference timing and/or base pair values. In some configurations, blocks 410-446 may include logic and memory configured to execute the functions of reference mark decoder 250 in FIG. 2 and associated operations described with regard to FIGS. 3A and 3B. Block 454 may include logic and memory configured to execute functions of oligo index decoder 256 and block 452 may include logic and memory configured to execute functions of oligo set sorter 258. Blocks 456-468 may include logic and memory configured to execute functions of data consensus correction 260. Block 466 may include logic and memory configured to execute functions of insertion/deletion correction 252, erasure identifier 254, and/or subsequent error correction by data consensus correction 260, iterative data decoder, 262, symbol decoder 264, RLL decoder 266, and/or CRC 268. Blocks 410-468 may be embodied in hardware circuits and/or software modules executed using a processor and memory, such as processor 242 and memory 244 in FIG. 2.

At block 410, read data for an oligo copy may be received in memory. Convolutional matrix logic 412 may generate a convolutional matrix based on separating reference mark positions and user data positions into alternating columns and then offsetting those pairs of columns by one base pair for a sequence of offset positions in both directions. Next reference selector 414 may select a target reference pattern from reference set 416 to use for a first iteration of scoring the most likely path through a corresponding correlation matrix for the convolutional matrix and reference matrix based on the selected reference pattern. Reference matrix logic 418 may access or generate a corresponding reference matrix for the selected matrix pattern, such as by repeating the reference pattern across the columns of the reference matrix. XOR comparator 420 may include logic to execute an XOR comparison of each corresponding value in the convolutional matrix and the two reference matrices to populate a correlation matrix 422. For example, XOR comparator 420 may execute XOR logic between the values from each row of the matrices and return a 0 value for matched base pairs and a 1 value for different base pairs. Example correlation matrix 350 is shown in FIG. 3A, where the light gray areas indicate different base pairs, and the medium gray areas indicate matched base pairs. At this stage, x-indicators 380 for the most likely path may not yet be determined.

Viterbi logic 430 may operate on correlation matrix 422 to determine probability values for each correlation value in the matrix based on traversing the matrix with a Viterbi algorithm. As described above, Viterbi logic 430 may be configured with a Toeplitz matrix 432 to bias the probabilities for single offset changes from the offset position of the prior reference mark position. Viterbi logic 430 may determine a highest probability among the values in each row of correlation matrix 422, as indicated by x-indicators 380 in example correlation matrix 350. In some configurations, Viterbi logic 430 may execute for multiple traverses of correlation matrix 422 and/or portions thereof based on different reference pattern segments encoded in the reference marks. In some configurations, Viterbi logic 430 may be executed through multiple traversals, such as a first (alpha) direction traversal and a second (beta) direction traversal. The resulting probability values for each matrix position may then be summed or otherwise combined by traversal summation 438. Each Viterbi operation may result in a set of probability data for correlation matrix 422 that may be output as Viterbi soft information 450. For example, Viterbi soft information 450 may include a matrix of probability values corresponding to the entries in correlation matrix 422. In some configurations, Viterbi logic 430 may operate on other configurations of correlation matrices, including correlations between copies of an oligo, where another copy of the oligo or a previously determined best copy from multiple copies is used to generate the reference matrix.

Most likely path logic 440 may use the probability values determined by Viterbi logic 430 directly or through the summation of multiple traversals of correlation matrix 422 to determine the most likely value (and corresponding offset column) for each row in correlation matrix 422. For example, the highest value in each row of example correlation matrices 350 may be annotated with indicator (x) 380 for the highest values, as determined by most likely path logic 440. The results of most likely path logic 440 may be evaluated by Viterbi scoring logic 442 to determine whether the reference mark alignment along the most likely path provides sufficient confidence that the reference mark timing can be accurately recovered. For example, Viterbi scoring logic 442 may sum the probabilities for each column without normalization to determine a confidence score for reference timing based on the selected reference pattern and corresponding reference matrix.

In some configurations, blocks 414-442 may be executed for each reference pattern in reference set 416 for the convolutional matrix from the read data. In some configurations, a reference set counter may be incremented to track progress through the reference set each time a next reference pattern from reference set 416 may be selected by next reference selector 414. The reference set counter may determine when confidence scores have been determined for each reference pattern using Viterbi scoring logic 442, and operation may proceed to score comparison logic 444. Score comparison logic 444 may compare the Viterbi scores for each reference pattern and corresponding reference matrix to determine the most likely reference pattern. For example, the reference pattern with the highest score or score closest to 1 may be selected as the most likely reference pattern. Reference determination logic 446 may receive an indicator of the most likely reference pattern and the corresponding Viterbi score. In some configurations, reference determination logic 446 may also include a confidence threshold for determining whether the most likely reference pattern is sufficiently reliable to use for further error correction and decoding. If that threshold is met, blocks 452 and 454 may use the selected reference pattern for oligo address determination and/or oligo copy sorting and/or blocks 458-468 may use the corresponding Viterbi soft information 450 from the correlation matrix for the selected reference pattern to execute insertion and/or deletion corrections to attempt to restore the original reference mark timing and/or other correlation-based base pair corrections.

In some configurations, reference marks and the reference patterns they include may encode the oligo index or oligo address. Once the most likely reference pattern is determined for the read data by reference determination logic 446, the oligo address may be determined from the reference pattern. Oligo address logic 454 may process the most likely reference pattern to determine the oligo address that it encodes, such as by reference patterns that are uniquely mapped to each oligo address in the oligo pool. In some configurations, this may include dividing the most likely reference pattern into a series of reference pattern segments, where each reference pattern segment maps to an oligo address segment value. The series of oligo address segment values may then be combined to recover the full oligo address. In some configurations, the oligo address may be encoded with one or more sets of redundancy data, and oligo address logic may perform an oligo address redundancy check to validate the oligo address or components thereof based on the oligo address data and corresponding redundancy data. Once the oligo address is successfully determined and validated, it may be used by oligo sorting logic 452 to sort copies of the oligo with the same oligo address into sets of multiple copies that can be used for consensus-based error correction using blocks 456-468 and/or reassemble the original data unit by combining the oligo data from the oligos in the oligo pool. Both oligo error correction and reassembly may include additional layers of error correction encoded in the oligo data.

The output of oligo sorting logic 452 may allow number of copies logic 456 to determine the number of copies of each oligo in the read data from the oligo pool. In some configurations, number of copies logic 456 may use the number of copies for each oligo to determine the processing path and consensus functions to be used for that particular oligo. For example, number of copies logic 456 may include one or more number of copy thresholds for determining the consensus processing. An oligo with only a single copy may not be eligible for consensus processing, but a number of copies greater than one may be able to use soft information consensus correction. In some configurations, the number of copies threshold may determine which processing path and corresponding consensus function is used for processing the soft information from the multiple copies. A first path and corresponding below threshold logic 458 may be used for number of copies below the threshold value and a second path and corresponding above threshold logic 462 may be used if the number of copies meets or exceeds the threshold. Additional numbers of thresholds, paths, and corresponding consensus functions are possible. Both below threshold logic 458 and above threshold logic 462 may operate on Viterbi soft information 450 received from Viterbi logic 430 but may select different portions of the soft information to operate on. For example, below threshold logic 458 may use a reference mark consensus function 460 that operates specifically on the soft information for the reference mark positions from a corresponding correlation matrix. Above threshold logic 462 may use a base pair consensus function 464 that operates on the soft information for the oligo data payload and/or the combination of the reference data positions and the oligo data payload positions. Each consensus function may operate to aggregate base pair probabilities for the positions of interest across the number of copies available and may generate a consensus most likely path and resulting “best copy” for further processing by error correction logic 466.

In some configurations, one or more thresholds or number of copy values may correspond to consensus decisions that use multiple consensus functions and combine their results. For example, the number of copies may be passed to weighting factor logic 468 configured to generate a weighting factor that determines the relative contributions of multiple consensus functions. Alternatively, different thresholds may correspond to specific waiting factors. For example, less than three copies may result in a 100% reference mark consensus function, three to five copies may result in a 50/50 ratio and corresponding weighting factors between reference mark consensus function and base pair consensus function, and greater than five copies may result in a 100% base pair consensus function.

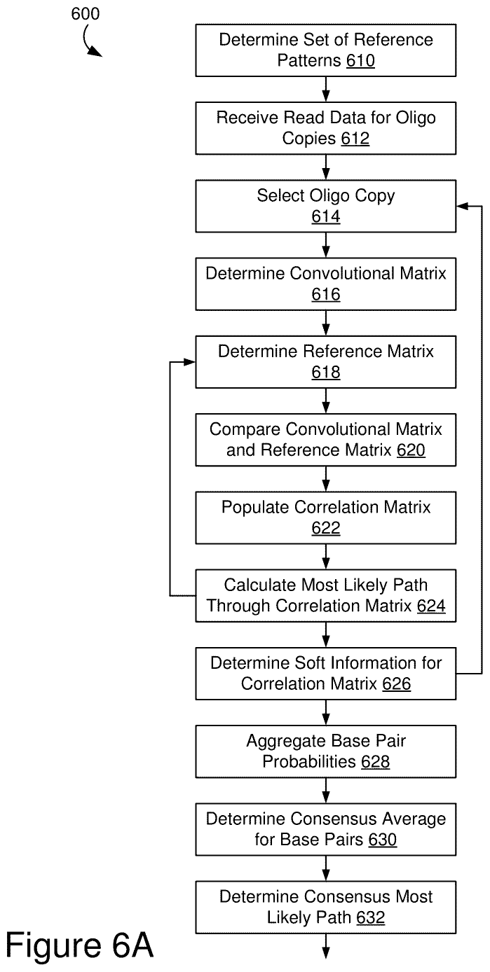

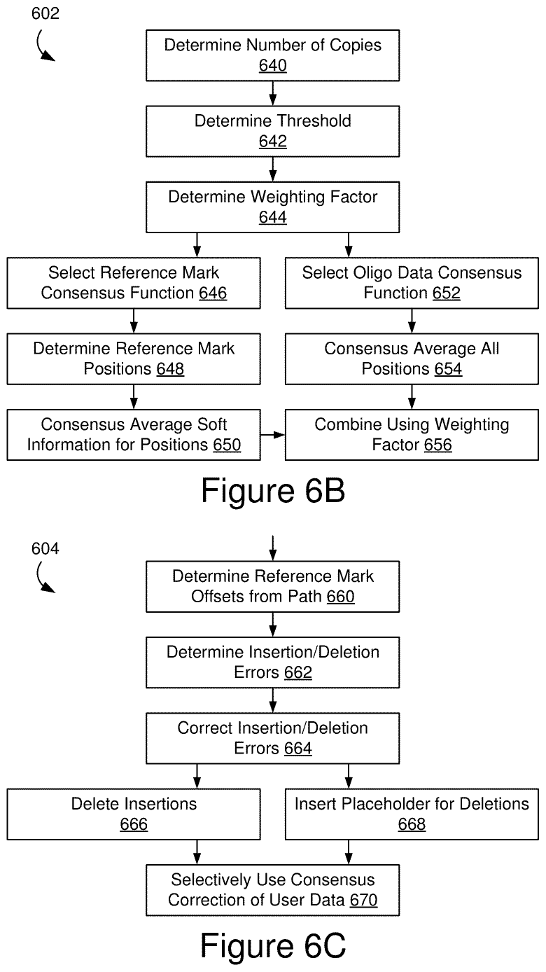

As shown in FIGS. 6A, 6B, and 6C, the decoder in decoding system 240 may be operated according to an example method of recovering reference timing from embedded reference marks in oligo read data and using consensus averaging of soft information for correcting insertion and deletion errors, i.e., according to the method 600 illustrated by blocks 610-670. In some configurations, sub-method 602 in FIG. 6B may selectively use one or two consensus functions to determine the most likely path. In some configurations, sub-method 604 may use the soft information consensus to establish reference mark locations and use them to correct insertion/deletion errors.

At block 610, a set of reference patterns may be determined. For example, the decoder may be configured with a set of reference patterns that include different sequences of reference mark values that correspond to one or more convolutional codes that are easily detected and statistically distinguishable from the oligo data.

At block 612, read data may be received for an oligo. For example, the decoder may receive a sequence of base pairs corresponding to an oligo to be decoded.

At block 614, an oligo copy may be selected from the set of read data. For example, the read data from the oligo pool amplification and sequencing may include an unknown number of copies of each oligo that may be grouped into sets of oligo copies at one or more stages of data processing.

At block 616, a convolutional matrix may be determined. For example, the decoder may separate the reference data positions from the user data positions, organize them into paired columns, and then repeat those columns for a desired number of offsets in each direction, such as 5-6 single base pair offsets.

At block 618, a reference matrix may be determined for the oligo. For example, the decoder may repeat the base pairs from a selected reference pattern for each column of the reference matrix to match the number of columns in the convolutional matrix. In some configurations, the decoder may be configured to sequentially process each reference pattern from the set of reference patterns against the read data to determine the reference pattern that results in the best fit for the reference marks.

At block 620, the convolutional matrix may be compared to the reference matrix. For example, the decoder may use an exclusive-or to compare the base pair values in the convolutional matrix with the corresponding matrix position in the selected reference matrix.

At block 622, a correlation matrix may be populated. For example, the decoder may place a corresponding value from the comparisons at block 620 in the corresponding matrix position in a correlation matrix.

At block 624, a most likely path through the correlation matrix may be calculated or otherwise determined. For example, the decoder may apply a Viterbi algorithm to traverse the correlation matrix to determine relative probability values in each row of the correlation matrix for possible shifts in reference mark positions. In some configurations, a Viterbi score for each reference pattern and corresponding reference matrix may be calculated and compared for determining the reference matrix at block 618.

At block 626, soft information for the correlation matrix may be determined. For example, the decoder may use the probabilities generated by the Viterbi algorithm for each entry in the correlation matrix to determine a set of soft information for that oligo copy. If there are additional oligo copies to be evaluated, method 600 may return to block 614 to select a next oligo copy to be evaluated for reference mark recovery and error correction.

At block 628, base pair probabilities may be aggregated for each copy of the oligo. For example, the decoder may use the probabilities from each oligo copy's set of soft information to determine probability values for each possible base pair in each position of the oligo copy (reference positions and/or payload data positions).

At block 630, the consensus average for each base pair across oligo copies may be determined. For example, the decoder may use the base pair probabilities for each oligo copy determined at block 628 to execute one or more consensus functions targeting some or all positions in the set of oligo copies to determine a most likely base pair value for each position.

At block 630, a consensus most likely path may be determined. For example, the decoder may use the base pair values determined by consensus averaging at block 630 to determine the most likely path for the reference pattern, corresponding reference marks, and/or intervening payload data positions for further processing.

At block 640, a number of copies may be determined. For example, the decoder may determine the number of copies using an oligo set sorting function at one or more points in the data processing sequence.

At block 642, a threshold number of copies may be determined. For example, the decoder may be configured with one or more thresholds for determining whether and which consensus functions may be used based on the number of copies of that oligo.

At block 644, a weighting factor may be determined. For example, in some configurations, the decoder may include a weighing factor that enables the use of multiple consensus functions for the same set of oligo copies and corresponding soft information.

At block 646, a reference mark consensus function may be determined. For example, below the threshold value, the consensus function may be selectively used for determining the most likely values for reference mark timing.

At block 648, reference mark positions may be determined. For example, the decoder may use the reference mark frequency to determine the positions, soft information values, and reference pattern targets used for determining the consensus average.

At block 650, soft information may be consensus averaged using the reference mark consensus function. For example, the decoder may process the set of oligo copies using the reference function and data positions determined at blocks 646 and 648.

At block 652, an oligo data consensus function may be determined. For example, meeting or exceeding the threshold value, the consensus function may be selectively used for determining the most likely values for oligo payload data (and/or the combination of payload data values and reference mark values).

At block 654, soft information may be consensus averaged using the oligo data consensus function to process all data positions. For example, the decoder may process the set of oligo copies using the consensus function determined at block 652 for all base pair positions and aggregate base pair probabilities.

At block 656, consensus averages from two or more consensus functions may be combined using weighting factors. For example, the decoder may use the consensus averages from blocks 650 and 654 to determine a shared consensus most likely path that integrates the consensus averages for positions that have multiple consensus values using the weighting factor from block 644 to balance the relative contributions of the consensus functions.

At block 660, reference mark offsets may be determined from the consensus most likely path. For example, the decoder may interpret (relative to the most likely value in the prior row) shifts to the column on the left as one direction of offset and shifts to the column on the right as an opposite direction of offset.

At block 662, insertion and deletion errors may be determined from the offsets. For example, the decoder may evaluate the directions of the offsets as corresponding to sites of insertions or deletions in the oligo copy, such as left offsets corresponding to deletions and right offsets corresponding to insertions.

At block 664, insertion and deletion errors may be corrected in one or more of the oligo copies. For example, the decoder may include logic to insert placeholder values (which may be marked as erasures) for identified deletions at block 668 and delete base pairs identified as insertions at block 666 to compensate for errors and restore the reference mark timing of the user data segments between sequential reference marks.

At block 670, consensus correction of oligo payload or user data may be selectively used. For example, the decoder may use the soft information consensus averages of base pair values in the payload data positions where the soft information meets a consensus threshold prior to removing reference mark data and passing the resulting payload data for correction using error correction codes.

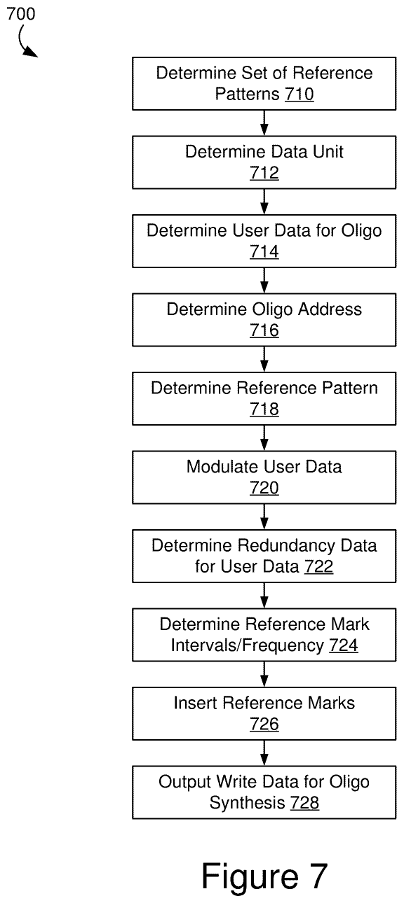

As shown in FIG. 7, the encoder in encoding system 210 may be operated according to an example method of encoding embedded reference marks that may include oligo index data in oligos, i.e., according to the method 700 illustrated by blocks 710-728.

At block 710, a set of reference patterns may be determined. For example, the encoder may be configured with a set of reference patterns that include different sequences of reference mark values that correspond to one or more convolutional codes that are easily detected and statistically distinguishable from the oligo data.

At block 712, a data unit may be determined. For example, the encoder may receive a data unit in a conventional binary data format for storage in a set of oligos.

At block 714, user data for the oligo may be determined. For example, an oligo formatter in the encoder may select a portion of user data from the data unit to be written to a target oligo.

At block 716, an oligo address may be determined for encoding the oligo. For example, the oligo formatter may determine an oligo address and/or other syntactic information to be included in the oligo to assist with recovery of the user data and mapping it into a larger user data structure or data unit (e.g., file or data object) that may also include encoding with redundancy data.

At block 718, a reference pattern for encoding reference marks in the oligo may be determined. For example, the encoder may include an index, data structure, or function for selecting reference patterns from a reference set and/or mapping the oligo address to corresponding reference patterns (e.g., distinct convolutional codes) from the set of reference patterns.

At block 720, user data may be modulated. For example, an RLL encoder or similar modulator may use a modulation code selected to assure that the user data does not include the selected reference mark code.

At block 722, redundancy data may be determined for the user data. For example, the user data may be encoded using an error correction code that generates corresponding redundancy data, such as parity data.

At block 724, reference mark intervals or frequency may be determined. For example, the reference mark formatter may be configured for a reference mark interval defining the number of base pairs that should appear between sequential reference marks in the oligo, which may be a single base pair for 0.5 reference mark frequency or code rate.

At block 726, reference marks may be inserted. For example, the reference mark inserter may insert the sequence of reference marks into the user data at the reference mark intervals to define a plurality of user data segments between each pair of sequential reference marks. The reference marks may correspond to the reference patterns selected at block 722 and ordered to form a complete reference pattern for all of the reference marks.

At block 728, write data for the oligo may be output for oligo synthesis. For example, the encoder may generate write data consisting of the user data segments for the target oligo and the reference marks (with embedded oligo index data) and any other added formatting data.

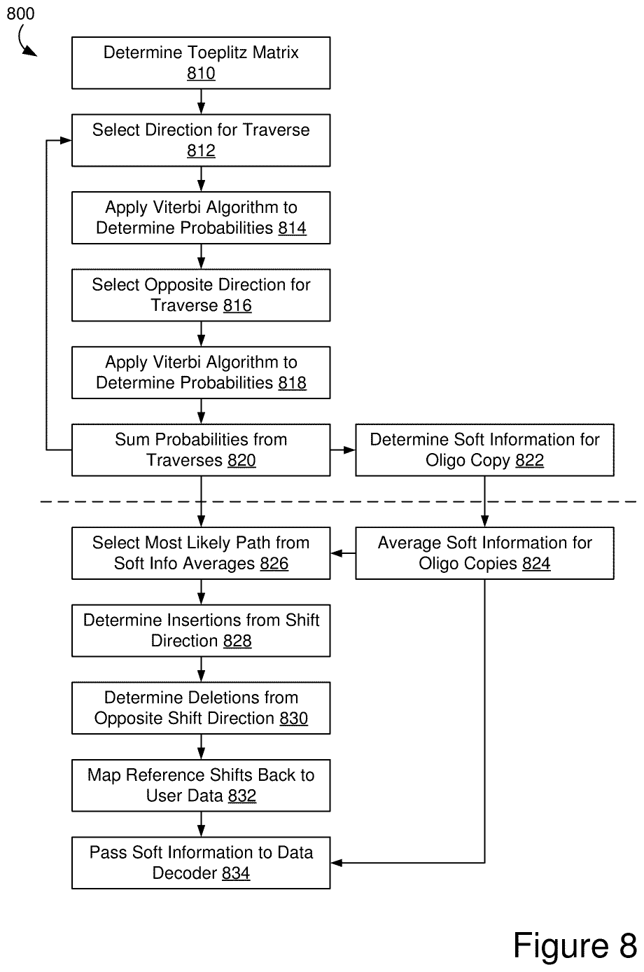

As shown in FIG. 8, the decoder in decoding system 240 and, more specifically, the reference mark decoder 250, may be operated according to an example method of determining probabilities of reference mark shifts using a Viterbi algorithm, i.e., according to the method 800 illustrated by blocks 810-834. In some configurations, the oligo data processing system 400 of FIG. 4 may be embodied at least in part in a reference mark decoder and/or data consensus correction decoder to execute method 800. In some configurations, method 800 may operate in the context of method 600 and, more specifically, provide further detail of the operations for blocks 624-632 on correlation matrices for generating soft information for multiple oligo copies.

At block 810, a Toeplitz matrix may be determined. For example, the decoder may include a Toeplitz matrix configured to modify probabilities for single base pair offsets from a prior reference offset position to determine column changes.

At block 812, a direction may be selected for traverse. For example, the decoder may be configured to traverse the correlation matrix in a first or alpha direction, such as from the top row or start of the read data sequence to the bottom row or end of the read data sequence.

At block 814, the Viterbi algorithm may be applied to determine probabilities for each position in the matrix based on the direction of traversal. For example, the decoder may calculate probabilities for each row through the correlation matrix based on the probability values calculated for the prior row in the correlation matrix based on the direction of the traversal.

At block 816, an opposite direction may be selected for traverse. For example, the decoder may be configured to traverse the correlation matrix in a second or beta direction, such as from the bottom row or end of the read data sequence to the top row or start of the read data sequence.

At block 818, the Viterbi algorithm may be applied to determine probabilities for each position in the matrix based on the direction of traversal. For example, the decoder may make the same calculations as at block 814, but in the opposite direction.

At block 820, probabilities from the traverses may be summed. For example, the decoder may combine the results for each position in the matrix across the two traverses in opposite directions, such as by adding, averaging, or variance calculation. In some configurations, operation may return to block 812 for a next copy of the oligo.

At block 822, soft information may be determined for each oligo copy. For example, the encoder may determine the matrix of probability values generated at blocks 814, and 818, and/or 820.

At block 624, the soft information from multiple oligo copies may be averaged. For example, the decoder may use one or more consensus functions based on the number of available copies to consensus average the likelihood of each possible base pair value for different oligo positions.

At block 826, a consensus most likely path may be selected from the consensus averaged soft information. For example, the decoder may evaluate the consensus averaged base pair values in each row of the matrix to determine which probability is the highest.

At block 828, insertions may be determined from shifts between adjacent rows in one direction. For example, the decoder may determine that column shifts between one row and the next (corresponding to adjacent reference mark positions) to the right correspond to insertion errors.

At block 830, deletions may be determined from shifts between adjacent rows in the opposite direction. For example, the decoder may determine that column shifts between one row and the next to the left correspond to deletion errors.

At block 832, reference mark shifts may be mapped back to user data. For example, the decoder may use the reference mark position shifts in the context of the full set of oligo positions (reference marks and user data) to locate insertions and deletions in the oligo read data in order to compensate for those shifts and correct reference mark positions/timing.

At block 834, the soft information may be passed to an iterative data decoder. For example, the decoder may pass the soft information to the iterative ECC decoder for the user data.

Technology for improved encoding and decoding of data for DNA storage is described above. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to particular hardware.

Reference in the specification to “one embodiment” or “an embodiment” means that a particular feature, structure, or characteristic described in connection with the embodiment is included in at least one embodiment or implementation of the disclosed technologies. The appearances of the phrase “in one embodiment” in various places in the specification are not necessarily all referring to the same embodiment or implementation.

Some portions of the detailed descriptions above may be presented in terms of processes and symbolic representations of operations on data bits within a computer memory. A process can generally be considered a self-consistent sequence of operations leading to a result. The operations may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), erasable programmable read-only memories (EPROMs), electrically erasable programmable read-only memories (EEPROMs), magnetic or optical cards, flash memories including USB keys with non-volatile memory or any type of media suitable for storing electronic instructions, each coupled to a computer system bus.

The disclosed technologies can take the form of an entire hardware implementation, an entire software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The terms storage media, storage device, and data blocks are used interchangeably throughout the present disclosure to refer to the physical media upon which the data is stored.

Finally, the processes and displays presented herein may not be inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

1. A system, comprising:
at least one decoder circuit configured to, alone or in combination:
receive read data determined from sequencing a set of oligos that includes multiple copies of an oligo and corresponds to at least a portion of an oligo pool configured to store a data unit;
determine, from the read data for each copy of the oligo, a convolutional matrix for that copy of the oligo, wherein each column of the convolutional matrix corresponds to a base pair offset of the read data for that copy of the oligo;
determine, for each copy of the oligo, a correlation matrix based on a comparison of the convolutional matrix for that copy of the oligo to a reference matrix;
determine, for each copy of the oligo, a most likely path through the correlation matrix for that copy of the oligo, wherein calculation of the most likely path generates a set of soft information for each element in the correlation matrix for that copy of the oligo;
determine, based on consensus averaging of the sets of soft information from at least two copies of the oligo, a consensus most likely path for the oligo; and
decode the oligo based on insertions and deletions indicated by the consensus most likely path.

2. The system of claim 1, wherein:
the reference matrix corresponds to a reference pattern encoded in the oligo as a series of reference marks having a predetermined interval; and
the predetermined interval of the series of reference marks corresponds to a single base pair between sequential reference marks in the series of reference marks.

3. The system of claim 1, wherein the at least one decoder circuit is further configured to, alone or in combination:
select the reference matrix from a plurality of reference matrices corresponding to different reference patterns in a set of reference patterns used to encode the reference marks in an oligo pool including the oligo;
iteratively execute, for the plurality of reference matrices:
determining the correlation matrix for that reference matrix; and
determining the most likely path for that reference matrix; and
determine, based on a comparison of the set of soft information for each reference matrix of the plurality of reference matrices, a most likely reference pattern for that copy of the oligo.

4. The system of claim 1, wherein a number of the multiple copies of the oligo in the read data is less than 10.

5. The system of claim 1, wherein determining the consensus most likely path for the oligo comprises:
for each copy of the oligo, aggregating, for each base pair along a length of that copy of the oligo, a probability of each possible base pair;
consensus averaging, across the copies of the oligo, the probabilities of each possible base pair; and
using a maximum probability value among the consensus averaged probabilities of each possible base pair to determine the most likely path.

6. The system of claim 1, wherein determining the consensus most likely path for the oligo comprises:
determining, based on the reference matrix for each copy of the oligo, positions in the correlation matrix for that copy of the oligo that correspond to a series of reference marks for that copy of the oligo; and
consensus averaging the soft information corresponding to the series of reference marks for each copy of the oligo to determine a most likely reference pattern for use in determining insertion and deletion errors in the at least two copies of the oligo.

7. The system of claim 1, wherein:
the at least one decoder comprises a plurality of consensus functions; and
the at least one decoder circuit is further configured to, alone or in combination:
determine a number of the multiple copies of the oligo; and
select, based on the number of the multiple copies, at least one consensus function of the plurality of consensus functions for determining the consensus most likely path.

8. The system of claim 7, wherein selecting the at least one consensus function of the plurality of consensus functions comprises:
selecting a first consensus function from the plurality of consensus functions responsive to the number of multiple copies of the oligo meeting a threshold number of copies; and
selecting a second consensus function from the plurality of consensus functions responsive to the number of multiple copies of the oligo not meeting the threshold number of copies.

9. The system of claim 7, wherein:
selecting the at least one consensus function of the plurality of consensus functions comprises:
selecting a first consensus function and a second consensus function from plurality of consensus functions; and
determining, based on the number of multiple copies of the oligo, a weighting value for determining relative contributions of the first consensus function and the second consensus function; and
determining the consensus most likely path is based on the first consensus function, the second consensus function, and the weighting value applied to the sets of soft information from the multiple copies of the oligo.

10. The system of claim 1, wherein:
the read data for the oligo pool comprises a distribution of numbers of copies of different oligos in the oligo pool; and
the read data is configured for the distribution to have a mean value in a range of 3 to 7 copies.

11. A method comprising:
receiving read data determined from sequencing a set of oligos that includes multiple copies of an oligo and corresponds to at least a portion of an oligo pool configured to store a data unit;
determining, from the read data for each copy of the oligo, a convolutional matrix for that copy of the oligo, wherein each column of the convolutional matrix corresponds to a base pair offset of the read data for that copy of the oligo;
determining, for each copy of the oligo, a correlation matrix based on a comparison of the convolutional matrix for that copy of the oligo to a reference matrix;
determining, for each copy of the oligo, a most likely path through the correlation matrix for that copy of the oligo, wherein calculation of the most likely path generates a set of soft information for each element in the correlation matrix for that copy of the oligo;
determining, based on consensus averaging of the sets of soft information from at least two copies of the oligo, a consensus most likely path for the oligo; and
decoding the oligo based on insertions and deletions indicated by the consensus most likely path.

12. The method of claim 11, wherein:
the reference matrix corresponds to a reference pattern encoded in the oligo as a series of reference marks having a predetermined interval; and
the predetermined interval of the series of reference marks corresponds to a single base pair between sequential reference marks in the series of reference marks.

13. The method of claim 11, further comprising:
selecting the reference matrix from a plurality of reference matrices corresponding to different reference patterns in a set of reference patterns used to encode the reference marks in an oligo pool including the oligo;
iteratively executing, for the plurality of reference matrices:
determining the correlation matrix for that reference matrix; and
determining the most likely path for that reference matrix; and
determining, based on a comparison of the set of soft information for each reference matrix of the plurality of reference matrices, a most likely reference pattern for that copy of the oligo.

14. The method of claim 11, further comprising:
for each copy of the oligo, aggregating, for each base pair along a length of that copy of the oligo, a probability of each possible base pair;
consensus averaging, across the copies of the oligo, the probabilities of each possible base pair; and
using a maximum probability value among the consensus averaged probabilities of each possible base pair to determine the most likely path.

15. The method of claim 11, further comprising:
determining, based on the reference matrix for each copy of the oligo, positions in the correlation matrix for that copy of the oligo that correspond to a series of reference marks for that copy of the oligo; and
consensus averaging the soft information corresponding to the series of reference marks for each copy of the oligo to determine a most likely reference pattern for use in determining insertion and deletion errors in the at least two copies of the oligo.

16. The method of claim 11, further comprising:
determining a number of the multiple copies of the oligo; and
selecting, based on the number of the multiple copies, at least one consensus function from a plurality of consensus functions for determining the consensus most likely path.

17. The method of claim 16, wherein selecting the at least one consensus function from the plurality of consensus functions comprises:
selecting a first consensus function from the plurality of consensus functions responsive to the number of multiple copies of the oligo meeting a threshold number of copies; and
selecting a second consensus function from the plurality of consensus functions responsive to the number of multiple copies of the oligo not meeting the threshold number of copies.

18. The method of claim 16, wherein:
selecting the at least one consensus function of the plurality of consensus functions comprises:
selecting a first consensus function and a second consensus function from plurality of consensus functions; and
determining, based on the number of multiple copies of the oligo, a weighting value for determining relative contributions of the first consensus function and the second consensus function; and
determining the consensus most likely path is based on the first consensus function, the second consensus function, and the weighting value applied to the sets of soft information from the multiple copies of the oligo.

19. The method of claim 11, wherein:
the read data for the oligo pool comprises a distribution of numbers of copies of different oligos in the oligo pool; and
the read data is configured for the distribution to have a mean value in a range of 3 to 7 copies.

20. A system comprising:
at least one processor;
at least one memory;
means for receiving read data determined from sequencing a set of oligos that includes multiple copies of an oligo and corresponds to at least a portion of an oligo pool configured to store a data unit;
means for determining, from the read data for each copy of the oligo, a convolutional matrix for that copy of the oligo, wherein each column of the convolutional matrix corresponds to a base pair offset of the read data for that copy of the oligo;
means for determining, for each copy of the oligo, a correlation matrix based on a comparison of the convolutional matrix for that copy of the oligo to a reference matrix;
means for determining, for each copy of the oligo, a most likely path through the correlation matrix for that copy of the oligo, wherein calculation of the most likely path generates a set of soft information for each element in the correlation matrix for that copy of the oligo;
means for determining, based on consensus averaging of the sets of soft information from at least two copies of the oligo, a consensus most likely path for the oligo; and
means for decoding the oligo based on insertions and deletions indicated by the consensus most likely path.
